(19) United States
(12) Patent Application Publication
(10) Pub. No.: US 2026/0301261 A1
(43) Pub. Date: Oct. 1, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Jungo HARIGAI, Kanagawa (JP); Hirotake SASAKI, Kanagawa (JP); Nanaka IKEDA, Kanagawa (JP); Yoshitaka KUWADA, Kanagawa (JP)

(73) Assignee: FUJIFILM Business Innovation Corp., Tokyo (JP)

(21) Appl. No.: 19/296,118

(22) Filed: Aug. 11, 2025

(30) Foreign Application Priority Data
Mar. 26, 2025 (JP) 2025-051769

(51) Int. Cl. G06T 11/60

(52) U.S. Cl. CPC G06T 11/60

(57) ABSTRACT

An information processing system that generates a video to be displayed by a display which displays a video within a field of view of a user who views a real space and which includes an imager facing a direction of the user's gaze, the information processing system including a processor configured to: acquire out-of-range information, which is information about an out-of-range space, which is a space located near the display and located outside an imaging range of the imager; and generate, as a display video, which is the video to be displayed by the display, a display video that reflects the acquired out-of-range information.

### CROSS-REFERENCE TO RELATED APPLICATIONS

This application is based on and claims priority under 35 USC 119 from Japanese Patent Application No. 2025-051769 filed Mar. 26, 2025.

### BACKGROUND

### (i) Technical Field

The present invention relates to an information processing system and a non-transitory computer readable medium.

### (ii) Related Art

Japanese Unexamined Patent Application Publication No. 2007-233523 discloses a process for estimating the top of the head of a person from each of person regions and estimating a three-dimensional position of the top of the head of the person using position information about the tops of the heads in preceding and following frames and a reference frame.

Japanese Unexamined Patent Application Publication No. 2017-103602 discloses a process for estimating a three-dimensional position of a person using object information having the same tracking label or information about the height of an average person when the head of the person is outside an image region where fields of view of cameras overlap.

Japanese Unexamined Patent Application Publication No. 2021-117130 discloses an apparatus including a three-dimensional position estimation unit that estimates three-dimensional coordinates of an object and a three-dimensional position correction unit that corrects a depth of a three-dimensional map on the basis of differences in imaging characteristics between a monocular camera and an imaging camera.

WO 2018/173205 discloses a process for generating information about relative positions and installation directions of first and second detection devices on the basis of data regarding a distance to a predetermined point on an object and information about a direction of the object acquired by the first detection device and data regarding a distance to the predetermined point on the object and information about a direction of the object acquired by the second detection device.

### SUMMARY

When a display is used to display a video within a field of view of a user viewing a real space, the user can view both the real space and the video.

Here, it is assumed that the display is provided with an imager that acquires a video of the surroundings. As a result, the information acquired by the imager can be reflected in the video displayed within the user's field of view. On the other hand, in this case, information about the outside of an imaging range of the imager cannot be reflected in the video displayed by the display.

Aspects of non-limiting embodiments of the present disclosure relate to making it possible to reflect, in a video displayed by a display within a field of view of a user, information about the outside of an imaging range of an imager provided for the display.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system that generates a video to be displayed by a display which displays a video within a field of view of a user who views a real space and which includes an imager facing a direction of the user's gaze, the information processing system comprising a processor configured to: acquire out-of-range information, which is information about an out-of-range space, which is a space located near the display and located outside an imaging range of the imager; and generate, as a display video, which is the video to be displayed by the display, a display video that reflects the acquired out-of-range information.

### BRIEF DESCRIPTION OF THE DRAWINGS

An exemplary embodiment of the present disclosure will be described in detail based on the following figures, wherein:

FIG. 1 is a diagram illustrating an overall configuration of a display system;

FIG. 2 is a diagram illustrating configuration of a management server;

FIG. 3 is a diagram illustrating a hardware configuration of a display;

FIGS. 4A and 4B are diagrams illustrating a process executed by the display system according to the present exemplary embodiment;

FIG. 5 is a diagram showing a database stored in an information storage of the management server;

FIG. 6 is a diagram showing another example of a display video generated by a control processing unit (CPU) of the management server;

FIG. 7 is a diagram illustrating another example of the display video;

FIG. 8 is a diagram illustrating a process for generating parameters by the CPU of the management server;

FIGS. 9A to 9F are diagrams for the process for generating parameters;

FIG. 10 is a diagram illustrating another example of the process for generating parameters by the CPU of the management server;

FIGS. 11A and 11B are diagrams illustrating processing in step S205;

FIG. 12 is a diagram illustrating another example of the process for generating parameters;

FIGS. 13A to 13E are diagrams illustrating details of the process for generating parameters;

FIG. 14 is a diagram illustrating another example of the process for generating parameters;

FIGS. 15A to 15D are diagrams illustrating details of the process;

FIG. 16 is a diagram illustrating another example of the process for generating parameters;

FIGS. 17A to 17D are diagrams illustrating details of the process;

FIG. 18 is a diagram illustrating individual dimension information stored in the information storage;

FIG. 19 is a diagram illustrating attributes of nearby persons; and

FIGS. 20A to 20C are diagrams illustrating a method for identifying a distance in a case where an overall camera is an omnidirectional camera.

### DETAILED DESCRIPTION

An exemplary embodiment of the present invention will be described hereinafter with reference to the accompanying drawings.

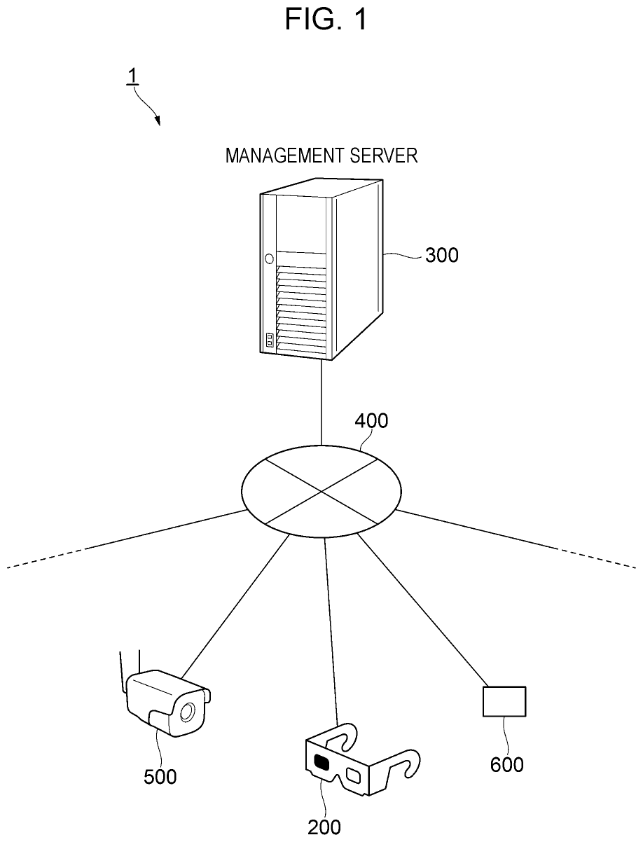

FIG. 1 is a diagram illustrating an overall configuration of a display system 1 according to the present exemplary embodiment.

The display system 1 includes a management server 300. The display system 1 also includes displays 200 to be worn by target persons described later.

Although only one display 200 is illustrated in FIG. 1, a plurality of displays 200 is provided in accordance with the number of target persons.

The display 200 is an eyeglass-type display 200. The display 200 is worn on the head of the target person. The display 200 displays a video within a field of view of a target person, who is a user of the display 200. As a result, the target person views the video.

In the present exemplary embodiment, the display 200 displays a video within the field of view of the user viewing a real space.

The target person views the surroundings through the display 200.

In the exemplary embodiment, an overall camera 500 as an example of an imaging apparatus is provided.

The overall camera 500 acquires a video of an entire space where the target person is present. The video includes the video on the display 200 and a video of the target person wearing the display 200. The video also includes a video of nearby persons (described later) near the target person.

The overall camera 500 is provided for each of locations of the target person. When there is a plurality of locations of the target person, a plurality of overall cameras 500 is provided.

A type of overall camera 500 is not particularly limited as long as the overall camera 500 can acquire a video. Examples of the overall camera 500 include a monocular camera and an omnidirectional camera described later.

The omnidirectional camera refers to a camera capable of capturing a 360°video therearound.

In the present exemplary embodiment, individual microphones 600 worn by the nearby persons are also provided. The individual microphones 600 acquire voices of the nearby persons and generate audio information.

The individual microphone 600 is provided for each of the nearby persons, and when there is a plurality of nearby persons, a plurality of individual microphones 600 is provided.

The display 200, the overall camera 500, and the individual microphones 600 are connected to the management server 300 via a communication network 400 such as the Internet.

### Configuration of Management Server 300

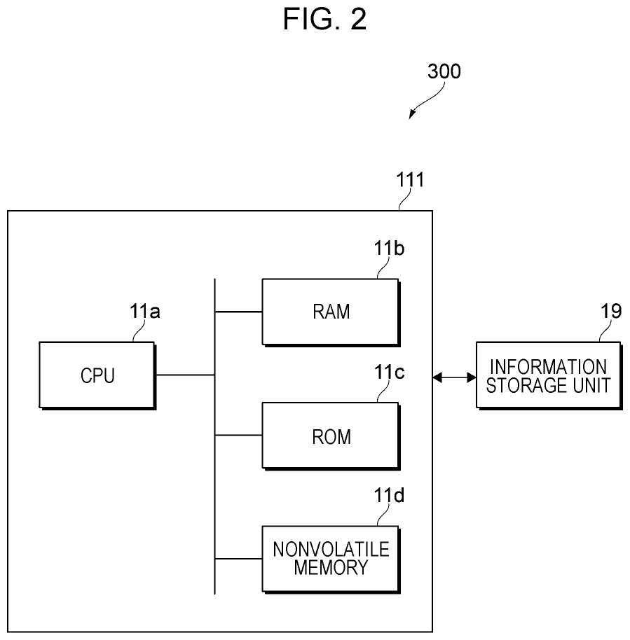

FIG. 2 is a diagram illustrating configuration of the management server 300. The management server 300 is implemented by a computer.

The management server 300 includes an arithmetic processing unit 111 that executes digital arithmetic processing in accordance with a program and an information storage 19 that stores information.

The information storage 19 is implemented by an existing information storage device. The information storage 19 is implemented by, for example, a hard disk drive (HDD), a semiconductor memory, or a magnetic tape.

The arithmetic processing unit 111 includes a CPU 11a as an example of a processor.

In addition, the arithmetic processing unit 111 is provided with a RAM 11b used as a working memory of the CPU 11a or the like and a ROM 11c in which programs to be executed by the CPU 11a are stored.

The arithmetic processing unit 111 includes a rewritable nonvolatile memory 11d that can retain data even when power is not supplied.

The nonvolatile memory 11d is, for example, a battery-backed SRAM or a flash memory. The information storage 19 stores various types of information such as programs to be executed by the arithmetic processing unit 111.

According to the present exemplary embodiment, when the CPU 11a provided for the arithmetic processing unit 111 reads the programs stored in the ROM 11c or the information storage 19, various types of processing performed by the management server 300 are executed.

The programs to be executed by the processor CPU 11a may be provided for the management server 300 via a storage medium.

Examples of the storage medium include magnetic storage media such as a magnetic tape and a magnetic disk. Another example of the storage medium is an optical storage medium such as an optical disc.

Another example of the storage medium is a magneto-optical storage medium. Another example of the storage medium is a semiconductor memory.

The programs to be executed by the CPU 11a may be provided for the management server 300 via communication means such as the Internet.

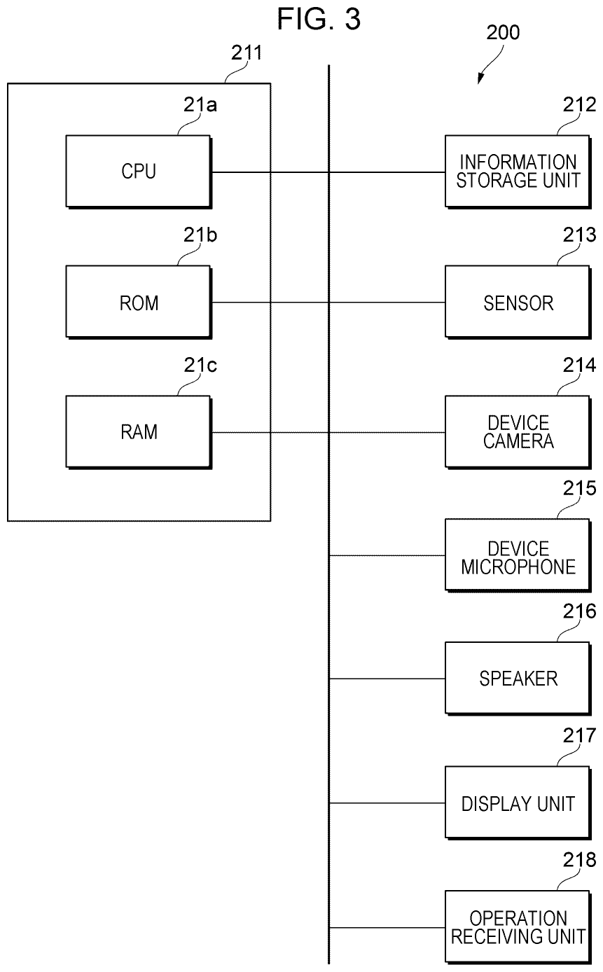

FIG. 3 is a diagram illustrating hardware configuration of the display 200.

The display 200 includes an arithmetic processing unit 211, an information storage 212, a sensor 213, a device camera 214, a device microphone 215, a speaker 216, a display unit 217, and an operation receiving unit 218.

The arithmetic processing unit 211 includes a CPU 21a as an example of a processor.

The arithmetic processing unit 211 is provided with a RAM 21c used as a working memory of the CPU 21a or the like and a ROM 21b in which programs to be executed by the CPU 21a are stored.

The information storage 212 is implemented by an existing information storage device such as a semiconductor memory.

Examples of the sensor 213 include a GPS sensor and a direction sensor. With reference to an output of the sensor 213, a current position of the display 200 and an orientation

### Of the Display 200 Can Be Identified.

The device camera 214 as an example of an imager is a camera that captures an image of the surroundings of the display 200.

When the display 200 is worn by the target person, the device camera 214 faces a forward direction of the target person and captures an image in the forward direction. In other words, the device camera 214 faces a direction in which the target person is facing and captures an image in a front direction of the target person. The device camera 214 is provided in such a way as to face a direction of a gaze of the target person, who is the user of the display 200.

The device microphone 215 acquires a voice of the target person and generates audio information.

The speaker 216 outputs a sound or a voice and performs notification processing for the target person wearing the display 200.

The display unit 217 is a so-called display and displays various types of information. With the display 200 worn by the target person, the display unit 217 is arranged in front of the target person's eyes.

In the present exemplary embodiment, a video acquired by the device camera 214 is displayed on the display unit 217. With the display 200 worn by the target person, the display unit 217 displays a video showing a situation in front of the target person.

In the present exemplary embodiment, the target person views the real space in front of thereof by referring to the video displayed on the display unit 217.

The operation receiving unit 218 is a functional unit that receives an operation from the user. The operation receiving unit 218 includes, for example, a switch or a touch panel.

Alternatively, the display 200 may be a transmissive display 200.

In the transmissive display 200, a transparent display unit 217 that allows the target person to view a scene behind the display unit 217 is provided as the display unit 217.

The target person views the scene behind the display unit 217 through the display unit 217. In other words, the target person views a scene in front of thereof through the display unit 217.

With the transmissive display 200, the target person views the real space behind the display unit 217 that can be seen through the display unit 217 and a video displayed on the display unit 217.

A program executed by the CPU 21a may be provided for the display 200 via a storage medium.

Examples of the storage medium include magnetic storage media such as a magnetic tape and a magnetic disk. Another example of the storage medium is an optical storage medium such as an optical disc.

Another example of the storage medium is a magneto-optical storage medium. Another example of the storage medium is a semiconductor memory.

The program executed by the CPU 21a may be provided for the display 200 using communication means such as the Internet.

The display 200 is not limited to the glasses-type display 200 and may be, for example, a smartphone or a tablet terminal.

The glasses-type display 200, the smartphone, the tablet terminal, and the like are all devices that can be carried by the target person.

The smartphone and the tablet device are also provided with the display unit 217 and the device camera 214. The target person can view the scene in front thereof by referring to the video captured by the device camera 214 and displayed on the display unit 217.

In other words, in this case, the target person can view a space located in front of thereof and behind the smartphone or tablet terminal by referring to the display unit 217 provided for the smartphone or tablet terminal placed in front thereof.

In the present exemplary embodiment, as will be described later, the target person is notified of content of utterances of nearby persons via the display 200. The display 200 is not limited to a glasses-type display, and even when a smartphone or a tablet terminal is used, this notification can be performed.

### Description of Processing Executed by Display System

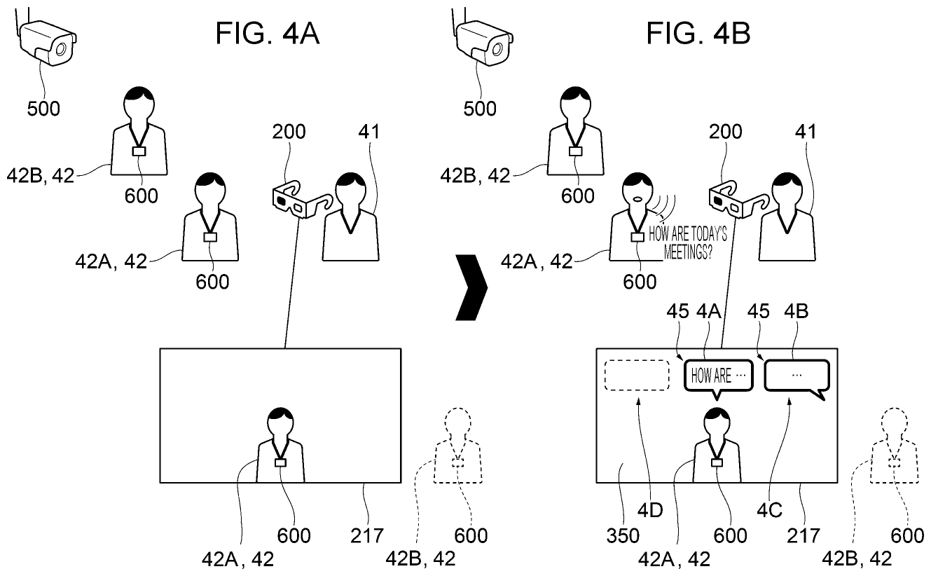

FIGS. 4A and 4B are diagrams illustrating processing executed by the display system 1 according to the present exemplary embodiment.

FIG. 4A illustrates a target person 41 wearing the display 200 and nearby persons 42 located near the target person 41.

In this example, as the nearby persons 42, there are in-sight nearby persons 42A located within the field of view of the target person 41 and out-of-sight nearby persons 42B located outside the field of view of the target person 41.

The in-sight nearby persons 42A are located within an imaging range of the device camera 214 provided for the display 200 and within an imaging range of the overall camera 500.

The out-of-sight nearby persons 42B are located outside the imaging range of the device camera 214 and within the imaging range of the overall camera 500.

Note that FIG. 4 does not illustrate the device camera 214.

In the present exemplary embodiment, the target person 41 wears the display 200.

In this example, as illustrated in FIG. 4A, the in-sight nearby persons 42A are displayed on the display unit 217 of the display 200.

Furthermore, in this example, as illustrated in FIG. 4A, each of the nearby persons 42 wears an individual microphone 600.

As described above, the display 200 according to the present exemplary embodiment is a glasses-type device. The glasses-type display 200 is worn on the head of the target person 41.

Through the display 200, the target person 41 views the nearby persons 42 near the target person 41. In other words, the target person 41 views the nearby persons 42 located in front thereof through the display 200. In other words, the target person 41 views the in-sight nearby persons 42A located in front thereof through the display 200.

When the target person 41 faces a direction different from the front direction, the target person 41 can view the out-of-sight nearby persons 42B through the display 200.

As illustrated in FIG. 3, the display 200 includes the device camera 214 and the display unit 217 that displays a video captured by the device camera 214.

The target person 41 views the in-sight nearby persons 42A by referring to the in-sight nearby persons 42A captured by the device camera 214 and displayed on the display unit 217.

Note that it is also assumed that the display 200 is the transmissive device described above. In this case, the target person 41 views the in-sight nearby persons 42A located behind the transparent display unit 217 through the display unit 217.

According to the present exemplary embodiment, in the state illustrated in FIG. 4A, the CPU 11a as an example of a processor provided for the management server 300 illustrated in FIG. 2 acquires audio information about the nearby persons 42, who are persons located near the target person 41.

The CPU 11a acquires, from the individual microphones 600, audio information acquired by the individual microphones 600, which are microphones worn by the nearby persons 42.

In the present exemplary embodiment, the audio information acquired by the individual microphones 600 is transmitted to the management server 300 via the communication network 400. The CPU 11a of the management server 300 acquires the audio information.

### Description of Database

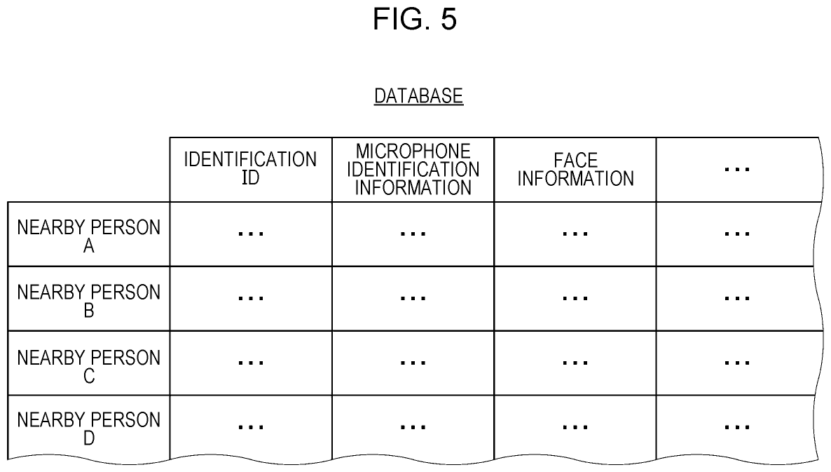

FIG. 5 illustrates a database stored in the information storage 19 of the management server 300.

In the present exemplary embodiment, as illustrated in FIG. 2, the management server 300 includes the information storage 19. In the present exemplary embodiment, information about each nearby person 42 is registered for the nearby person 42 in the database illustrated in FIG. 5, which is stored in the information storage 19.

In the present exemplary embodiment, an identification ID as information used to identify each of the nearby persons 42 is registered in advance in the database for the nearby person 42. Additionally, microphone identification information, which is identification information for the individual microphone 600 possessed by each nearby person 42, face information about the nearby person 42, and the like are registered in the database for the nearby person 42.

In the present exemplary embodiment, the faces of the nearby persons 42 are captured in advance. Face information, which is information about the faces of the nearby persons 42, is registered in the database.

As the face information, images of the faces of the nearby persons 42 and information about feature values of the faces of the nearby persons 42 acquired by analyzing the image are registered.

In the present exemplary embodiment, the video acquired by the device camera 214, the video acquired by the overall camera 500, and the audio information acquired by the individual microphones 600 are transmitted to the management server 300.

On the basis of the video acquired by the device camera 214 and the audio information, the CPU 11a of the management server 300 identifies the in-sight nearby persons 42A displayed on the display unit 217, and further acquires the audio information about the in-sight persons 42A.

On the basis of the video acquired by the overall camera 500 and the audio information, the CPU 11a of the management server 300 identifies the nearby persons 42 shown in the video acquired by the overall camera 500, and further acquires the audio information about the nearby persons 42.

The CPU 11a of the management server 300 acquires the video captured by the device camera 214. The CPU 11a of the management server 300 then identifies the in-sight nearby persons 42A, who are nearby persons 42 shown in the video, on the basis of the image of the face of the in-sight nearby person 42A and the face information stored in the database.

The CPU 11a of the management server 300 also acquires the video image acquired by the overall camera 500. The video acquired by the overall camera 500 includes the in-sight nearby persons 42A and the out-of-sight nearby persons 42B as the nearby persons 42.

The CPU 11a of the management server 300 identifies the nearby persons 42 shown in the video on the basis of the images of the faces of the nearby persons 42 captured by the overall camera 500 and the face information stored in the database.

The CPU 11a of the management server 300 acquires the audio information acquired by the individual microphones 600. The CPU 11a of the management server 300 acquires microphone identification information transmitted to the management server 300 together with the audio information.

On the basis of the microphone identification information and the microphone identification information stored in the database in advance, the CPU 11a of the management server 300 identifies to whom the audio information transmitted from the individual microphones 600 belongs.

Each individual microphone 600 stores microphone identification information for identifying the individual microphone 600.

The audio information acquired by the individual microphones 600 and the microphone identification information are transmitted from the individual microphones 600 to the management server 300.

The CPU 11a of the management server 300 identifies the nearby persons 42 from whom the audio information has been acquired by the individual microphones 600 on the basis of the microphone identification information and the microphone identification information registered in the database.

In the present exemplary embodiment, an individual microphone 600 is prepared for each nearby person 42.

In the present exemplary embodiment, the individual microphones 600 provided for each nearby person 42 acquires the audio information about the nearby person 42.

In the present exemplary embodiment, as described above, the audio information acquired by the individual microphones 600 is transmitted to the management server 300 together with the microphone identification information.

The CPU 11a of the management server 300 identifies the nearby persons 42 on the basis of the microphone identification information and acquires the audio information about the identified nearby persons 42.

More specifically, in the present exemplary embodiment, when the audio information is transmitted from each individual microphone 600 to the management server 300, the individual microphone 600 selects audio information whose sound pressure exceeds a predetermined threshold from among the audio information acquired by the individual microphone 600.

The selected audio information is then transmitted from the individual microphone 600 to the management server 300 together with the microphone identification information.

As a result, in the present exemplary embodiment, the transmission of audio information about a nearby person 42 other than the nearby person 42 wearing the individual microphone 600 to the management server 300 through the individual microphone 600 is suppressed.

The other nearby person 42 is away from the microphone wearing nearby person 42, who is the nearby person 42 wearing the individual microphone 600. In this case, sound pressure of a voice of the other nearby person 42 acquired by the individual microphone 600 is usually low.

When audio information with a sound pressure exceeding a predetermined threshold is selected and transmitted to the management server 300, the transmission of the audio information about the other nearby person 42 to the management server 300 via the individual microphone 600 of the microphone wearing nearby person 42 is suppressed.

Note that the management server 300 may select audio information with a sound pressure exceeding the predetermined threshold.

In this case, the management server 300 selects audio information with a sound pressure exceeding the predetermined threshold from among the audio information transmitted from the individual microphone 600.

The management server 300 then acquires the selected audio information as the audio information of the microphone wearing nearby person 42.

Alternatively, the CPU 11a of the management server 300 may acquire audio information about each nearby person 42 on the basis of audio information acquired by a microphone provided for a terminal carried by the nearby person 42. Examples of the terminal device carried by each nearby person 42 include a smartphone and a tablet terminal.

In addition, a common microphone may be provided, and the CPU 11a of the management server 300 may acquire audio information about each nearby person 42 on the basis of audio information acquired by the common microphone.

When a common microphone is used, feature information, which is information about features of a voice of each nearby person 42, is registered in advance in the database.

On the basis of the feature information registered in the database, the CPU 11a of the management server 300 identifies and acquires the audio information about each nearby person 42.

Alternatively, audio information about each nearby person 42 may be acquired by using a multidirectional microphone.

When a multidirectional microphone is used, the multidirectional microphone is installed at the center of the plurality of nearby persons 42 located in such a way as to be arranged in a ring.

Furthermore, directions in which the plurality of nearby persons 42 is viewed from the multidirectional microphone and nearby person identification information for identifying the nearby persons 42 are stored in advance in the database in association with each other.

When the multidirectional microphone acquires audio information, the multidirectional microphone acquires information about a direction of a position where an utterance that has served as a basis for the audio information has been made.

In this case, the CPU 11a of the management server 300 acquires, from the database, nearby person identification information associated with the direction identified from the acquired information about the direction. As a result, the CPU 11a of the management server 300 identifies a nearby person 42 who has made the utterance.

In the present exemplary embodiment, the CPU 11a of the management server 300 acquires audio information about each in-sight nearby person 42A on the basis of the video acquired by the device camera 214 and the audio information acquired by the individual microphones 600.

The CPU 11a of the management server 300 acquires audio information about each in-sight nearby person 42A shown in the video acquired by the device camera 214.

The CPU 11a of the management server 300 acquires the audio information about each nearby person 42 on the basis the video acquired by the overall camera 500 and the audio information acquired by the individual microphones 600. As described above, the nearby persons 42 include both the in-sight nearby persons 42A and the out-of-sight nearby persons 42B.

The CPU 11a of the management server 300 acquires the audio information about each nearby person 42 shown in the video acquired by the overall camera 500.

After acquiring the audio information, the CPU 11a of the management server 300 analyzes the audio information and acquires utterance content, which is content of an utterance of the nearby person 42.

The CPU 11a of the management server 300 analyzes the audio information transmitted from the individual microphone 600 worn by the nearby person 42, and acquires the utterance content of the nearby person 42. The utterance content based on the audio information may be acquired by a known method.

Next, the CPU 11a of the management server 300 generates a display video for displaying an utterance content image, which is an image representing the acquired utterance content, on the display unit 217 in association with the nearby person 42 who has uttered the utterance content.

The CPU 11a of the management server 300 transmits the generated display video to the display 200.

In response to this, as illustrated in FIG. 4B, a generated display video 350 is displayed on the display unit 217 of the display 200.

In this display video 350, an utterance content image 45 (4A), which is an image representing the utterance content of the nearby person 42, is displayed.

The utterance content image 45 denoted by reference numeral 4A is displayed in association with the in-sight nearby persons 42A shown in the video acquired by the device camera 214.

The display video 350 illustrated in FIG. 4B also includes an utterance content image 45 (4B) representing content of an utterance made by the out-of-sight nearby person 42B.

The display video 350 illustrated in FIG. 4B also includes the utterance content image 45 of the out-of-sight nearby person 42B located in an out-of-range space.

The “out-of-range space” refers to a space located outside the imaging range of the device camera 214. The display video 350 illustrated in FIG. 4B includes the utterance content image 45 representing the content of the utterance of the out-of-sight nearby person 42B located in the out-of-range space.

In the present exemplary embodiment, as described above, the utterance content image 45, which is an image representing the content of the utterance made by the nearby person 42, is displayed. As a result, the utterance content image 45 appears in the field of view of the target person 41.

In this case, even when the target person 41 has a hearing impairment, the target person 41 can recognize the content of the utterance of the nearby person 42.

The CPU 11a of the management server 300 generates the display video 350 on the basis of an imager video, which is a video acquired by the device camera 214 as an example of an imager, acquired in-range information, and acquired out-of-range information.

The “in-range information” refers to information about the in-sight nearby persons 42A present in the in-range space, which is the space located within the imaging range of the device camera 214.

The “out-of-range information” refers to information about the out-of-sight nearby persons 42B located in the out-of-range space, which is the space located outside the imaging range of the device camera 214.

A part of the management server 300 where the CPU 11a is provided may be regarded as an information processing system that generates a video to be displayed by the display 200.

In the present exemplary embodiment, the CPU 11a of the management server 300 generates the display video 350, which is the video to be displayed by the display 200. Therefore, the part of the management server 300 where the CPU 11a is provided may be regarded as an information processing system that generates the display video 350 to be displayed by the display 200.

An installation location of a generation function unit that generates the display video 350 to be displayed by the display 200 is not particularly limited. The generation function unit may be provided for the display 200.

In this case, the generation functional unit provided for the display 200 serves as an information processing system that generates the display video 350.

The generation function unit may be distributed to both the display 200 and the management server 300.

In the present exemplary embodiment, each process is executed by an arbitrary computer. Any computer may execute these processes using a processor as hardware, a program as software, or a combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be constituted by a programmable logic device, such as a central processing unit (CPU), a micro processing unit (MPU), or a field-programmable gate array (FPGA), a dedicated circuit for executing a specific process, such as an application-specific integrated circuit (ASIC), or hardware, such as a graphic processing unit (GPU) or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The process performed by the management server 300 will be further described.

When generating the display video 350 illustrated in FIG. 4B, the CPU 11a of the management server 300 identifies each of in-sight nearby persons 42A displayed on the display unit 217 illustrated in FIG. 4A.

The CPU 11a of the management server 300 identifies each of the in-sight nearby persons 42A displayed on the display unit 217 on the basis of the in-range video, which is the video acquired by the device camera 214 illustrated in FIG. 3.

On the basis of the video of the in-sight nearby persons 42A shown in the in-range image acquired by the device camera 214 and the face information registered in the database, the CPU 11a of the management server 300 identifies each in-sight nearby person 42A displayed on the display unit 217.

The CPU 11a of the management server 300 associates the utterance content image 45 with the in-sight nearby person 42A who has made the utterance among the identified in-sight nearby persons 42A.

In other words, the CPU 11a of the management server 300 associates the utterance content image 45 with the in-sight nearby person 42A from whom the audio information has been acquired among the identified in-sight nearby persons 42A.

The CPU 11a determines a position of the in-sight nearby person 42A shown in the in-range video acquired by the device camera 214 as a display position of the utterance content image 45.

Using the method described later, the CPU 11a acquires position coordinates of the in-sight nearby person 42A, and determines a position identified on the basis of the position coordinates as the display position for the utterance content image 45.

In the present exemplary embodiment, for example, the CPU 11a determines a position near the head of the in-sight nearby person 42A on the in-range video acquired by the device camera 214 as the display position of the utterance content image 45.

When generating the display video 350 illustrated in FIG. 4B, the CPU 11a of the management server 300 specifies each of the out-of-sight nearby persons 42B who are not displayed on the display unit 217 on the basis of the video acquired by the overall camera 500.

Specifically, in this case, first, the CPU 11a of the management server 300 identifies each of the nearby persons 42 on the basis of the video of the nearby persons 42 shown in the video acquired by the overall camera 500 and the face information registered in the database.

The CPU 11a of the management server 300 then identifies, as the out-of-sight nearby persons 42B, persons other than those who have already been identified as the in-sight nearby persons 42A among the identified nearby persons 42.

The CPU 11a of the management server 300 acquires position coordinates of each of the out-of-sight nearby persons 42B shown in the video acquired by the overall camera 500 in a display coordinate system, which is a coordinate system of the display 200.

On the basis of the acquired position coordinates, the CPU 11a of the management server 300 determines a display position of the utterance content image 45 corresponding to the out-of-sight nearby person 42B.

The CPU 11a adds the utterance content image 45 to the determined display position in the generated display video 350.

As described above, the CPU 11a of the management server 300 acquires position coordinates of each out-of-sight nearby person 42B.

When, for example, a position identified from the acquired position coordinates is on a right side when viewed from the target person 41, the utterance content image 45 is added to a position 4C in FIG. 4B.

When the position identified from the acquired position coordinates is on a left side when viewed from the target person 41, for example, the utterance content image 45 is added to a position 4D in FIG. 4B.

In the present exemplary embodiment, the display video 350 generated by CPU 11a includes the utterance content image 45 corresponding to the out-of-sight nearby person 42B.

The CPU 11a of the management server 300 acquires the position coordinates of the out-of-sight nearby person 42B in the display coordinate system.

When acquiring the position coordinates, the CPU 11a of the management server 300 first acquires the position coordinates of the out-of-sight nearby person 42B in an imaging coordinate system, which is a coordinate system of the overall camera 500.

The CPU 11a of the management server 300 acquires the position coordinates of the out-of-sight nearby person 42B in the imaging coordinate system on the basis of a vector extending from an origin of the video captured by the overall camera 500 toward the out-of-sight nearby person 42B shown in the video.

A method for acquiring the position coordinates will be described in detail later.

Next, the CPU 11a of the management server 300 transforms the position coordinates in the imaging coordinate system into position coordinates in the display coordinate system, which is the coordinate system of the display 200.

As a result, the CPU 11a of the management server 300 acquires the position coordinates of the out-of-sight nearby person 42B in the display coordinate system.

On the basis of the position coordinates of the out-of-sight nearby person 42B in the display coordinate system, the CPU 11a of the management server 300 determines the display position of the utterance content image 45 of the out-of-sight nearby person 42B.

The CPU 11a then generates the display video 350 in which the utterance content image 45 is added at the position identified by the determined display position.

As a result, in the present exemplary embodiment, the display video 350 illustrated in FIG. 4B is displayed.

In the display video 350, the utterance content image 45 of the out-of-sight nearby person 42B located in the out-of-range space is displayed at the position 4C.

When generating the display video 350 to be displayed by the display 200, the CPU 11a of the management server 300 generates the display video 350 that reflects the out-of-range information.

The CPU 11a of the management server 300 acquires the out-of-range information, which is information about the out-of-range space that is a space located near the display 200 and outside the imaging range of the device camera 214. The CPU 11a of the management server 300 acquires, as the out-of-range information, position information and audio information about the out-of-sight nearby persons 42B located in the out-of-range space.

The CPU 11a of the management server 300 generates the display video 350 that reflects the acquired out-of-range information.

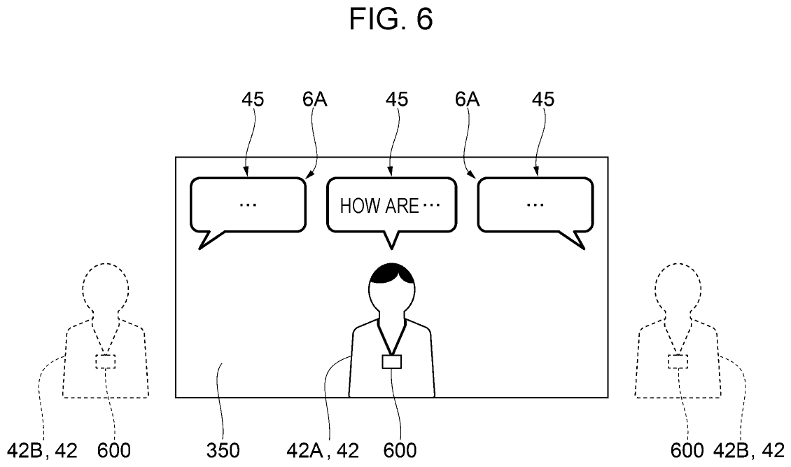

FIG. 6 is a diagram illustrating another example of the display video 350 generated by the CPU 11a of the management server 300.

When a plurality of out-of-sight nearby persons 42B is located outside the imaging range, the display video 350 generated by the CPU 11a of the management server 300 is, for example, a display video 350 illustrated in FIG. 6.

In the display video 350, utterance content images 45 (6A) are displayed in association with the plurality of out-of-sight nearby persons 42B.

When there is a plurality of in-sight nearby persons 42A (not illustrated), utterance content images 45 are displayed in association with the in-sight nearby persons 42A.

In the present exemplary embodiment, information based on the in-range video, which is the video acquired by the device camera 214 provided for the display 200, is included in the display video 350.

Furthermore, in the present exemplary embodiment, information about the outside of the imaging range of the device camera 214 is also included in the display video 350.

As a result, in the present exemplary embodiment, the target person 41 becomes aware of not only information about the in-sight nearby persons 42A located within his/her field of view but also information about the out-of-sight nearby persons 42B located outside his/her field of view.

In the present exemplary embodiment, the CPU 11a of the management server 300 acquires, as the in-range information, target object information that is information about specific target objects located in the in-range space. The CPU 11a of the management server 300 also acquires target object information that is information about specific target objects located in the out-of-range space.

In the present exemplary embodiment, the specific target objects are nearby persons 42, who are humans. The specific target objects are not limited to humans, and may be objects other than humans.

The CPU 11a of the management server 300 then generates, as the display video 350, a display video 350 that reflects the target object information.

When generating the display video 350, as described above, the CPU 11a of the management server 300 first acquires the position information and the audio information about the in-sight nearby persons 42A located in the in-range space as the target object information.

As the target object information, the CPU 11a of the management server 300 also acquires the position information and the audio information about the out-of-sight nearby persons 42B located in the out-of-range space.

The CPU 11a of the management server 300 generates the display video 350 that reflects the position information and the audio information about the in-sight nearby persons 42A and the position information and the audio information about the out-of-sight nearby persons 42B.

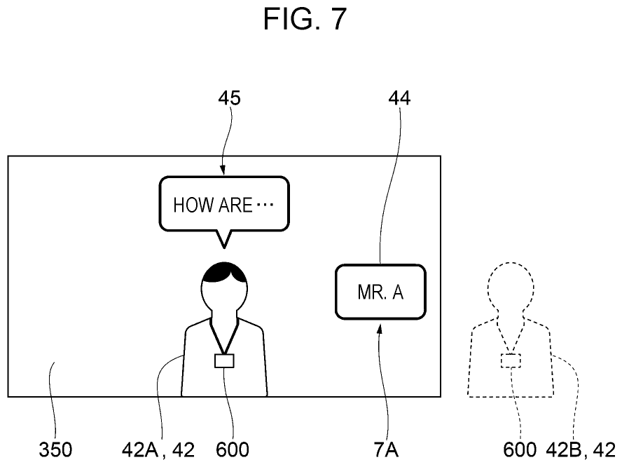

FIG. 7 is a diagram illustrating another example of the display video 350.

Alternatively, as illustrated in FIG. 7, the CPU 11a of the management server 300 may display an image 44 (7A) representing a name of a person in the generated display video 350 at a position identified from position information about an out-of-sight nearby person 42B.

The image 44 representing the name of the person is an image representing a name of the out-of-sight nearby person 42B.

The CPU 11a of the management server 300 may display the image 44 representing the name of the out-of-sight nearby person 42B instead of an utterance content image 45 of the out-of-sight nearby person 42B.

Alternatively, the CPU 11a of the management server 300 may display both the utterance content image 45 of the out-of-sight nearby person 42B and the image 44 representing the name of the out-of-sight nearby person 42B in the display video 350.

With regard to an in-sight nearby person 42A, too, an image representing a name of the in-sight nearby person 42A may be displayed in the display video 350 instead of an utterance content image 45 of the in-sight nearby person 42A.

Alternatively, with regard to an in-sight peripheral 42A, too, both the utterance content image 45 of the in-sight peripheral 42A and the image representing the name of the in-sight peripheral 42A may be displayed in the display video 350.

Alternatively, the CPU 11a of the management server 300 may further generate, on the basis of the position information about the out-of-sight nearby person 42B, control information that is information used to control the display 200 and that is used to perform control other than display control. Specifically, for example, the CPU 11a of the management server 300 may generate control information for causing a vibration source (not illustrated) provided for the display 200 to vibrate.

As a result, in this case, when a position identified from the acquired position coordinates is on the right side when viewed from the target person 41, for example, a vibration source located on a right ear side of the target person 41 is caused to vibrate among a plurality of vibration sources provided for the display 200. In this case, too, the target person 41 recognizes that the out-of-sight nearby person 42B is present on the right side when viewed from the target person 41.

When the position identified from the acquired position coordinates is on the left side when viewed from the target person 41, for example, a vibration source located on a left ear side of the target person 41 is caused to vibrate among the plurality of vibration sources provided in the display 200. In this case, the target person 41 recognizes that the out-of-sight nearby person 42B is present on the left side when viewed from the target person 41.

In the present exemplary embodiment, the CPU 11a of the management server 300 generates the display video 350 on the basis of the imager video, which is the video acquired by the device camera 214 provided for the display 200, the acquired in-range information, and the acquired out-of-range information.

As described above, examples of the in-range information include the position information and the audio information about the in-sight nearby person 42A. As described above, examples of the out-of-range information include the position information and the audio information about the out-of-sight nearby person 42B.

In the present exemplary embodiment, the overall camera 500 as an example of an imaging apparatus is provided separately from the display 200. The overall camera 500 captures at least an image of the out-of-range space. In the present exemplary embodiment, the overall camera 500 captures images of both the in-range space and the out-of-range space.

The CPU 11a of the management server 300 acquires the out-of-range information on the basis of a video image acquired by the overall camera 500. The CPU 11a of the management server 300 analyzes the video and acquires the out-of-range information.

As described above, the CPU 11a of the management server 300 then generates the display video 350 on the basis of the video acquired by the device camera 214, the in-range information, and the out-of-range information.

### Process for Transforming Position Information

First, the position information about the out-of-sight nearby person 42B, which is an example of out-of-range information, is acquired as position information in the imaging coordinate system, which is the coordinate system of the overall camera 500.

When acquiring the position information about the out-of-sight nearby person 42B, the CPU 11a of the management server 300 first acquires a video acquired by the overall camera 500.

On the basis of the video acquired by the overall camera 500, the CPU 11a of the management server 300 acquires the position information about the out-of-sight nearby person 42B in the imaging coordinate system, which is the coordinate system of the overall camera 500.

Here, the overall camera 500 is an imaging apparatus that acquires a video. The video acquired by the overall camera 500 may be regarded as an apparatus video acquired by the imaging apparatus.

Next, the CPU 11a of the management server 300 transforms the position information about the out-of-sight nearby person 42B in the imaging coordinate system into position information in the display coordinate system, which is the coordinate system of the display 200.

On the basis of the transformed position information, the CPU 11a of the management server 300 determines a display position of the out-of-range information to be included in the display video 350.

As a result, the position information about the out-of-sight nearby person 42B in the display coordinate system is reflected in the display video 350.

In the present exemplary embodiment, the coordinate system used when the position coordinates of the out-of-sight nearby person 42B are reflected in the generated display video 350 is the display coordinate system.

The position coordinates of the out-of-sight nearby person 42B, which are first acquired on the basis of the video captured by the overall camera 500, are position coordinates in the imaging coordinate system.

For this reason, in the present exemplary embodiment, the position information about the out-of-sight nearby person 42B in the imaging coordinate system is transformed into position information in the display coordinate system. On the basis of the transformed position information, a display video 350 reflecting the position information about the out-of-sight nearby person 42B is generated.

The process for transforming position information will be further described.

The CPU 11a of the management server 300 transforms the position information about the out-of-sight nearby person 42B in the imaging coordinate system into position information in the display coordinate system using parameters used for the transformation of position information.

When transforming the position information, the CPU 11a of the management server 300 first generates the parameters to be used for the transformation of position information.

The CPU 11a of the management server 300 then transforms the position information in the imaging coordinate system into position information in the display coordinate system using the generated parameters.

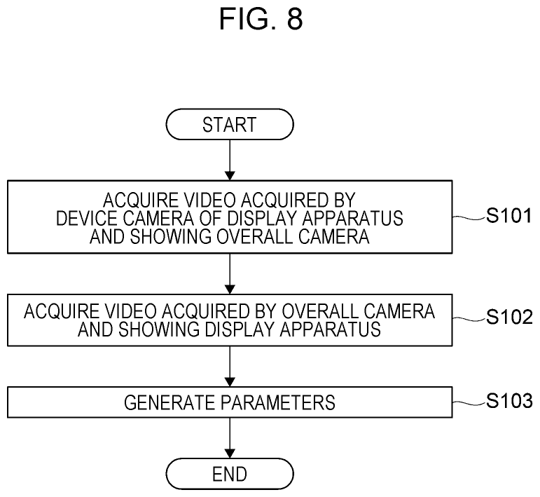

FIG. 8 is a diagram illustrating a process for generating the parameters performed by the CPU 11a of the management server 300.

First, the CPU 11a of the management server 300 acquires a video that has been acquired by the device camera 214 of the display 200 and that shows the overall camera 500 (step S101). This video will be referred to as an “individual/device video” hereinafter.

The overall camera 500 is a device that acquires a video, and a video that has been acquired by the device camera 214 and that shows the overall camera 500 will be referred to as an “individual/device video” in the present specification.

The CPU 11a of the management server 300 performs processing for searching for videos that have already been acquired and stored in the information storage 19 and acquires the individual/device video showing the overall camera 500.

In the present exemplary embodiment, the video acquired by the device camera 214 and the video acquired by the overall camera 500 are transmitted to the management server 300 and stored in the information storage 19.

The CPU 11a of the management server 300 performs the processing for searching for images stored in the information storage 19 and acquires the individual/device video showing the overall camera 500.

Next, the CPU 11a of the management server 300 acquires a video that has been acquired by the overall camera 500 and that shows the display 200 (step S102). This video will be referred to as an “overall/device video” in the present specification hereinafter.

The display 200 is a device that includes the device camera 214 and that acquires a video. In the present specification, the video that has been acquired by the overall camera 500 and that shows the display 200 as a device will be referred to as an “overall/device video”.

The CPU 11a of the management server 300 acquires, as the overall/device video, a video acquired at a timing when the individual/device video has been acquired among a plurality of videos showing the display 200.

The CPU 11a of the management server 300 acquires imaging time information, which is information about an imaging time associated with the individual/device video.

The CPU 11a of the management server 300 acquires, as the overall/device video, a video acquired at a timing closest to a time identified by the acquired imaging time information among a plurality of videos acquired by the overall camera 500 and showing the display 200.

The CPU 11a of the management server 300 then generates parameters to be used for the transformation of position information on the basis of the individual/device video showing the overall camera 500 and the overall/device video showing the display 200 (step S103).

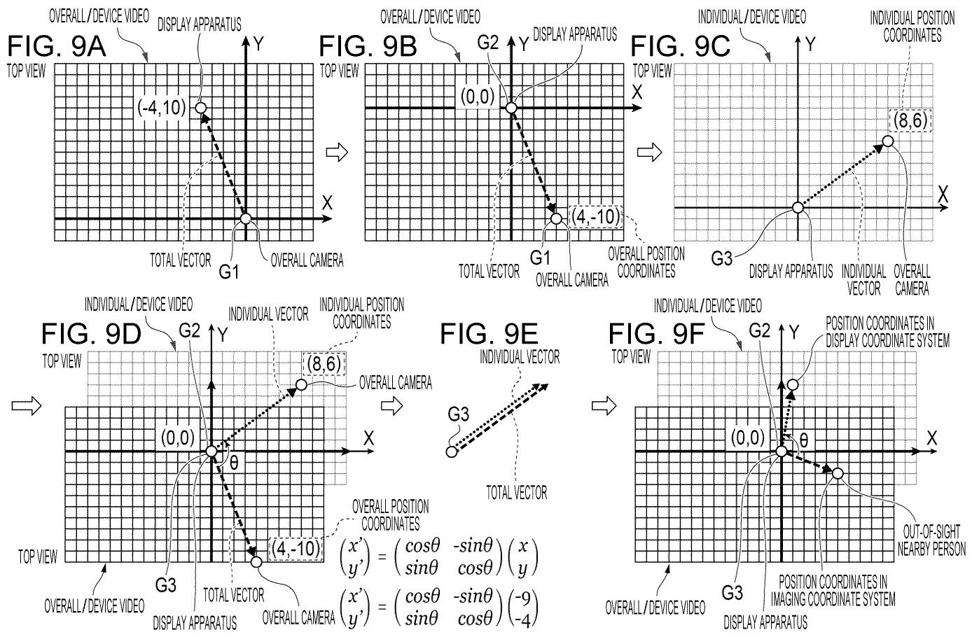

FIGS. 9A to 9F are diagrams illustrating the process for generating the parameters.

First, as illustrated in FIG. 9A, the CPU 11a of the management server 300 analyzes an overall/device video showing the display 200 and identifies the position of the display 200.

The CPU 11a of the management server 300 performs known image matching processing to identify the display 200 included in the overall/device video, and then identifies the position of the display 200.

The CPU 11a of the management server 300 identifies a position of the display 200 in a three-dimensional space whose origin G1 is the position of the overall camera 500. More specifically, position coordinates of the display 200 in the three-dimensional space are identified.

A method for identifying the position of the display 200 will be described.

When identifying the position of the display 200, the CPU 11a of the management server 300 first identifies a distance from the origin G1 to the display 200. A method for identifying the distance will be described later.

Furthermore, the CPU 11a of the management server 300 identifies a direction of the display 200 as viewed from the origin G1.

The CPU 11a of the management server 300 then identifies the position of the display 200 in the three-dimensional space on the basis of the distances from the origin G1 to the display 200 and the direction of the display 200 as viewed from the origin G1.

When the distance from the origin G1 to the display 200 and the direction of the display 200 as viewed from the origin G1 are identified, a vector from the origin G1 to the display 200 is acquired. In the present exemplary embodiment, the CPU 11a of the management server 300 identifies the position of the display 200 on the basis of this vector.

The CPU 11a of the management server 300 identifies the position of the display 200 in an X direction on the basis of magnitude of the vector from the origin G1 to the display 200 in the X direction.

The CPU 11a of the management server 300 identifies the position of the display 200 in a Y direction on the basis of magnitude of the vector in the Y direction.

The CPU 11a of the management server 300 identifies the position of the display 200 in a Z direction on the basis of magnitude of the vector in the Z direction.

As a result, the CPU 11a of the management server 300 identifies the position of the display 200 in the imaging coordinate system. Specifically, the CPU 11a of the management server 300 identifies the position coordinates of the display 200 in the imaging coordinate system.

Next, as illustrated in FIG. 9B, the CPU 11a of the management server 300 changes the origin.

The CPU 11a of the management server 300 sets the position where the display 200 is located as a new origin G2.

The CPU 11a of the management server 300 sets, as the new origin G2, the position identified from the position coordinates as the location where the display 200 is located.

The CPU 11a of the management server 300 acquires position information about the origin G1 relative to the new origin G2. The origin G1 in this case will be referred to as an “old origin G1” hereinafter.

In this case, on the basis of the position coordinates of the display 200 identified in FIG. 9A, the CPU 11a of the management server 300 acquires the position information about the old origin G1 relative to the new origin G2.

As a result, in this case, the CPU 11a of the management server 300 essentially acquires position information about the overall camera 500 in a case where the overall camera 500 is viewed from the display 200. More specifically, the CPU 11a of the management server 300 acquires the position coordinates of the overall camera 500.

These position coordinates will be referred to as “overall position coordinates” in the present specification hereinafter.

In the present exemplary embodiment, a vector from the new origin G2 to the old origin G1 can be identified on the basis of the overall position coordinates. This vector will be referred to as a “total vector” in this specification hereinafter.

Next, as illustrated in FIG. 9C, the CPU 11a of the management server 300 analyzes an individual/device video showing the overall camera 500, and identifies the position coordinates of the overall camera 500.

The CPU 11a of the management server 300 identifies the position coordinates of the overall camera 500 in a three-dimensional space whose origin G3 is the position where the display 200 is located.

This origin will be referred to as a “display coordinate system origin G3” in the present specification hereinafter.

When identifying the position coordinates of the overall camera 500, the CPU 11a of the management server 300 identifies a distance from the display coordinate system origin G3 to the overall camera 500 as in the above description.

When identifying the position coordinates of the overall camera 500, the CPU 11a of the management server 300 identifies a direction of the overall camera 500 as viewed from the display coordinate system origin G3.

On the basis of the identified distance and direction, the CPU 11a of the management server 300 identifies the position of the overall camera 500 in the three-dimensional space.

After the distance from the display coordinate system origin G3 to the overall camera 500 and the direction of the overall camera 500 as viewed from the display coordinate system origin G3 are identified, a vector from the display coordinate system origin G3 to the overall camera 500 is acquired.

In the present exemplary embodiment, the position of the overall camera 500 is identified on the basis of the vector.

Also in this case, as in the above description, the position of the overall camera 500 in the X direction is identified on the basis of magnitude of the vector in the X direction. On the basis of magnitude of the vector in the Y direction, the position of the overall camera 500 in the Y direction is identified. On the basis of magnitude of the vector in the Z direction, the position of the overall camera 500 in the Z direction is identified.

In the present specification, the vector will be referred to as an “individual vector” in the present specification hereinafter.

As a result, the CPU 11a of the management server 300 identifies the position coordinates of the overall camera 500 in the display coordinate system. The position coordinates will be referred to as “individual position coordinates” in this specification hereinafter.

Next, the CPU 11a of the management server 300 generates a pair of position coordinates including the overall position coordinates and the individual position coordinates.

On the basis of the generated pair of position coordinates, as illustrated in FIG. 9D, the CPU 11a of the management server 300 then calculates projective transformation values to be used to transform the position coordinates in the imaging coordinate system into the position coordinates in the display coordinate system.

The CPU 11a of the management server 300 sets projective transformation values that make values of the overall position coordinates equal to values of the individual position coordinates as the projective transformation values to be used to transform the position coordinates.

The CPU 11a of the management server 300 acquires the projective transformation values on the basis of a difference between a direction of the total vector from the new origin G2 toward the position identified from the overall position coordinates and a direction of the individual vector from the display coordinate system origin G3 toward the position identified from the individual position coordinates.

The CPU 11a of the management server 300 determines transformation values in a case where the direction of the total vector matches the direction of the individual vector as the projective transformation values.

Furthermore, as illustrated in FIG. 9E, the CPU 11a of the management server 300 acquires a scaling correction value, which is a coefficient for enlargement and reduction, on the basis of magnitude of the overall vector and magnitude of the individual vector after projective transformation is performed on the basis of the acquired projective transformation values.

While it is ideal that the magnitude of the overall vector matches the magnitude of the individual vector, there may be a case where the magnitudes do not match due to an error or the like.

In the present exemplary embodiment, therefore, the scaling correction value that causes the magnitude of the overall vector to match the magnitude of the individual vector is acquired.

The CPU 11a of the management server 300 acquires the scaling correction value by dividing the magnitude of the individual vector by the magnitude of the total vector.

As a result of the above process, the CPU 11a of the management server 300 acquires final parameters. The final parameters include the projective transformation values and the scaling correction value.

Thereafter, as illustrated in FIG. 9F, the CPU 11a of the management server 300 transforms the position coordinates on the basis of the acquired parameters.

On the basis of the acquired parameters, the CPU 11a of the management server 300 transforms the position coordinates of the out-of-sight nearby person 42B shown in the video acquired by the overall camera 500 in the imaging coordinate system into position coordinates in the display coordinate system.

When performing the transformation, the CPU 11a of the management server 300 first transforms the position coordinates of the out-of-sight nearby person 42B in the imaging coordinate system on the basis of the projective transformation values to acquire the transformed position coordinates.

Next, the CPU 11a of the management server 300 corrects the transformed position coordinates using the scaling correction value. The CPU 11a of the management server 300 corrects the transformed position coordinates by multiplying the transformed position coordinates by the scaling correction value.

As a result of the above process, the position coordinates of the out-of-sight nearby person 42B in the imaging coordinate system are transformed into position coordinates in the display coordinate system.

When transforming the position coordinates of the out-of-sight nearby person 42B, the position coordinates in the imaging coordinate system may be corrected using the scaling correction value to acquire corrected position coordinates in the imaging coordinate system.

Using the projective transformation values, the corrected position coordinates in the imaging coordinate system may be transformed into position coordinates in the display coordinate system.

As a result of the above process, the CPU 11a of the management server 300 acquires the position information about the out-of-sight nearby person 42B in the display coordinate system.

Thereafter, as described above, the CPU 11a of the management server 300 displays the utterance content image 45 in the generated display video 350 at the position identified by the position information.

The above parameters may be generated by arranging a specific common mark or a common scale in advance and capturing an image of the mark or the scale with both the device camera 214 and the overall camera 500.

In this case, it is necessary to construct an environment in which the common mark or the common scale is arranged in advance. In this case, time and preparation are required.

In contrast, in the present exemplary embodiment, the parameters for transformation can be generated without constructing such an environment.

When performing the process illustrated in FIG. 9, the user needs to set the display 200 in an upright position and set the overall camera 500 in an upright position.

For example, even when the overall camera 500 is installed upside down, the process illustrated in FIG. 9 can be performed. The parameters acquired in this case are different from originally intended parameters.

For this reason, when performing the process illustrated in FIG. 9, the user needs to set the display 200 in the upright position and set the overall camera 500 in the upright position.

When the process illustrated in FIG. 9 is performed, an overall/device video and an individual/device video that have a relationship in which a timing at which the overall/device video has been acquired matches a timing at which the individual/device video has been acquired are used.

When performing the process illustrated in FIG. 9, it is necessary to match the timing at which the overall/device video has been acquired with the timing at which the individual/device video has been acquired.

In the present exemplary embodiment, among a plurality of overall/device videos, an overall/device video acquired at a timing at which an individual/device video has been acquired is used to generate the parameters, thereby achieving timing matching.

The timing matching is not limited to perfect matching.

When a time lag between the timing at which the overall/device video has been acquired and the timing at which the individual/device video has been acquired is within a predetermined range, the timings are determined to be “matched”.

Alternatively, the CPU 11a of the management server 300 may acquire information about accuracy of the transformation of position coordinates.

In the present exemplary embodiment, by comparing the position coordinates in the display coordinate system acquired by using the above-described parameters with the position coordinates in the display coordinate system acquired on the basis of the video acquired by the device camera 214, information about the accuracy of the transformation of position coordinates can be acquired.

Position coordinates in the display coordinate system acquired using parameters will be referred to as “parameter-using position coordinates” in the present specification hereinafter. Position coordinates in the display coordinate system acquired on the basis of a video acquired by the device camera 214 will be referred to as “parameter-non-using position coordinates”.

When acquiring information about the accuracy of the transformation of position coordinates, first, for example, parameter-using position coordinates of one in-sight nearby person 42A shown in a video acquired by the overall camera 500 are acquired.

Parameter-non-using position coordinates of the in-sight peripheral 42A shown in the video acquired by the device camera 214 are also acquired.

The parameter-using position coordinates are compared with the parameter-non-using position coordinates. As a result, information about the accuracy of the transformation of position coordinates can be acquired. In other words, in this case, information about the accuracy of the generated parameters can be acquired.

More specifically, for example, the CPU 11a of the management server 300 first calculates a difference between the parameter-using position coordinates of the in-sight nearby person 42A and the parameter-non-using position coordinates of the in-sight nearby person 42A.

The CPU 11a of the management server 300 compares the calculated difference with a predetermined threshold and acquires information about the accuracy of the transformation of position coordinates.

When the difference is larger than the predetermined threshold, the CPU 11a of the management server 300 acquires information indicating that the accuracy of the transformation of position coordinates is low. When the difference is smaller than the predetermined threshold, on the other hand, the CPU 11a of the management server 300 acquires information indicating that the accuracy of the transformation of position coordinates is high.

When the CPU 11a of the management server 300 receives information indicating that the accuracy of the transformation of position coordinates is low, a warning may be issued to the target person 41 or an administrator of the display system 1.

The warning may be issued through the display 200 or a predetermined terminal device such as a personal computer (PC) or a smartphone.

When the CPU 11a of the management server 300 receives information indicating that the accuracy of the transformation of position coordinates is low, the CPU 11a of the management server 300 may restart the process described with reference to FIG. 9.

When the process described with reference to FIG. 9 is restarted, new parameters are generated on the basis of an individual/device video and an overall/device video that are different from the individual/device video and the overall/device video used above.

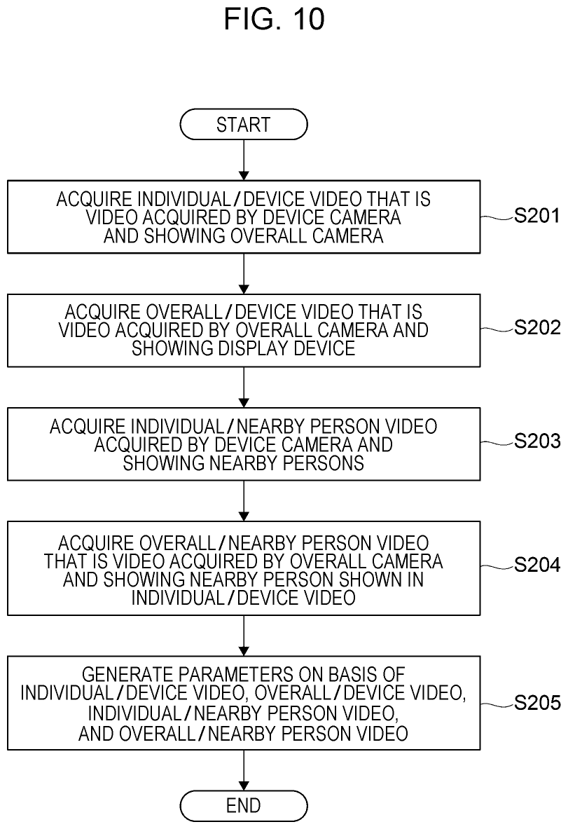

FIG. 10 is a diagram illustrating another example of the process for generating the parameters by the CPU 11a of the management server 300.

Also in this example, the CPU 11a of the management server 300 acquires an individual/device video that is a video acquired by the device camera 214 and showing the overall camera 500 (step S201).

In addition, also in this example, the CPU 11a of the management server 300 acquires an overall/device video that is a video acquired by the overall camera 500 and showing the display 200 (step S202).

Here, too, the CPU 11a of the management server 300 acquires, as the overall/device video, a video acquired at a timing that matches the timing at which the individual/device video has been acquired, from among a plurality of videos each showing the display 200.

Furthermore, in this example, the CPU 11a of the management server 300 acquires a video acquired by the device camera 214 and showing nearby persons 42 (step S203). This video will be referred to as an “individual/nearby-person video”.

In addition, the CPU 11a of the management server 300 acquires a video acquired by the overall camera 500 and showing the nearby persons 42 shown in the individual/device video (step S204). This video will be referred to as an “overall/nearby person video” hereinafter.

Here, too, the CPU 11a of the management server 300 acquires, as the overall/nearby person video, a video acquired at a timing that matches the timing at which the individual/nearby person video has been acquired.

In this example, common nearby persons 42 are included in the individual/nearby person video and the overall/nearby personal video. In the present specification, the common nearby persons 42 will be referred to as “common nearby persons 42” hereinafter.

Thereafter, the CPU 11a of the management server 300 generates parameters on the basis of the individual/device video, the overall/device video, the individual/nearby person video, and the overall/nearby person video (step S205).

In this example, an individual/device video, which is an example of a first video, an overall/device video, which is an example of a second video, an individual/nearby person video, which is an example of a third video, and an overall/nearby person video, which is an example of a fourth video, are acquired. The parameters are then generated on the basis of the four videos, that is, the first to fourth images.

Order of steps S201 to S204 is not limited to the above order. The order of execution of the four processing steps S201 to S204 may be another order, instead.

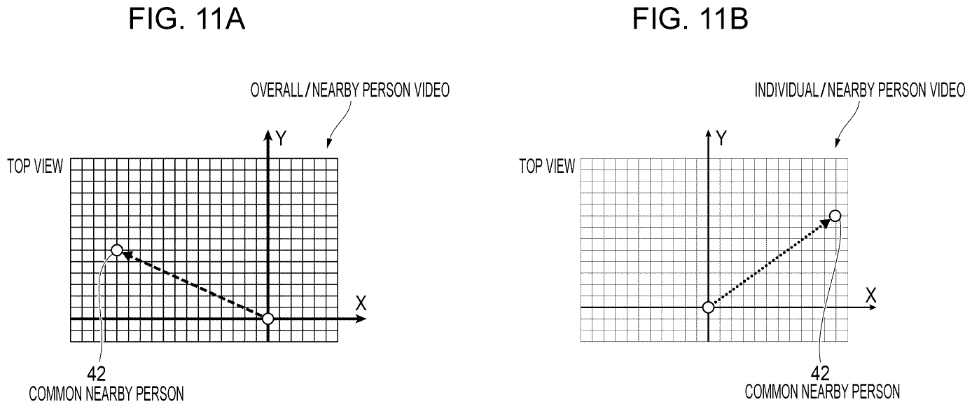

FIGS. 11A and 11B are diagrams illustrating the processing in step S205.

The process in step S205 will be described in detail.

In step S205, the CPU 11a of the management server 300 first generates the parameters on the basis of individual/device video and overall/device video.

This process for generating the parameters is the same as the process for generating the parameters illustrated in FIGS. 9A to 9F.

As a result, parameters based on the individual/device video and the overall/device video are generated.

Note that the parameters are temporary parameters. First, the temporary parameters are generated on the basis of the individual/device video and the overall/device video.

Furthermore, as illustrated in FIG. 11A, the CPU 11a of the management server 300 identifies position coordinates of the common nearby persons 42 on the basis of the overall/nearby person video. The position coordinates here are position coordinates in the imaging coordinate system.

Next, the CPU 11a of the management server 300 transforms the position coordinates of the common nearby persons 42 using the temporary parameters generated above.

As a result, the CPU 11a of the management server 300 acquires position coordinates of the common nearby persons 42 in the display coordinate system. That is, in this case, the CPU 11a of the management server 300 acquires the parameter-using position coordinates of the common nearby persons 42.

As illustrated in FIG. 11B, the CPU 11a of the management server 300 identifies the position coordinates of the common nearby persons 42 on the basis of the individual/nearby person video. The position coordinates here are position coordinates in the display coordinate system and correspond to parameter-non-using position coordinates.

The CPU 11a of the management server 300 acquires the parameter-non-using position coordinates of the common nearby persons 42.

Next, the CPU 11a of the management server 300 determines whether the parameter-using position coordinates match the parameter-non-using position coordinates.

Here, “match” refers to a state where a difference between the parameter-using position coordinates and the parameter-non-using position coordinates is within a predetermined range.

When the parameter-using position coordinates match the parameter-non-using position coordinates, the CPU 11a of the management server 300 sets the temporary parameters as final parameters.

When the parameter-using position coordinates do not match the parameter-non-using position coordinates, the CPU 11a of the management server 300 generates new parameters. The CPU 11a of the management server 300 then sets the new parameters as the final parameters.

Specifically, when generating a new parameter, the CPU 11a of the management server 300 first sets the parameter-using position coordinates and the parameter-non-using position coordinates as a pair of position coordinates.

The CPU 11a of the management server 300 then performs, on the basis of the pair of position coordinates, the same process as described above to calculate projective transformation values.

In this case, the CPU 11a of the management server 300 sets, as projective transformation values to be acquired, projective transformation values that make position coordinates identified from the parameter-using position coordinates equal to position coordinates identified from the parameter-non-using position coordinates.

The calculated projective transformation values will be referred to as “correction projective transformation values” in the present specification hereinafter.

The CPU 11a of the management server 300 sets, as final parameters, parameters including initial projective transformation values, which are projective transformation values acquired as a result of the generation of the temporary parameters, and the correction projective transformation values.

Depending on an installation situation of the overall camera 500, there can be a situation where the parameter-using position coordinates do not match the parameter-non-using position coordinates.

With the process described above, the CPU 11a of the management server 300 acquires the correction projective transformation values in addition to the initial projective transformation values so as to acquire the above new parameters.

The CPU 11a of the management server 300 then sets the new parameters as the final parameters.

When position coordinates of an out-of-sight nearby person 42B in the imaging coordinate system are transformed into position coordinates in the display coordinate system, these new parameters are used.

When the new parameters are used, first, the initial projective transformation values are used to transform the position coordinates of the out-of-sight nearby person 42B in the imaging coordinate system into first position coordinates in the display coordinate system.

Next, the first position coordinates are transformed into other position coordinates using the correction projective transformation value. The other position coordinates are set as final position coordinates of the out-of-sight nearby person 42B.

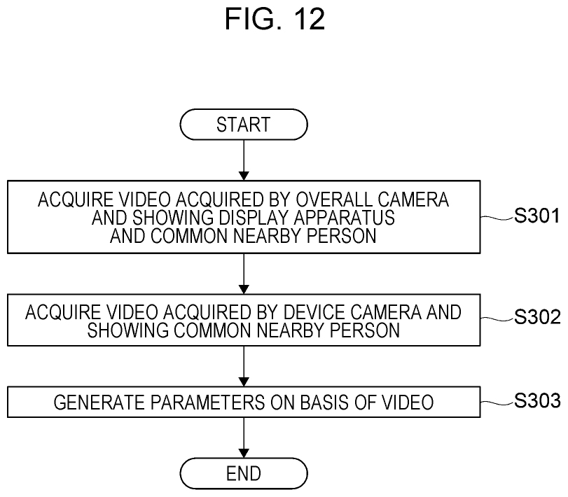

FIG. 12 is a diagram illustrating another example of the process for generating the parameters.

In this example, the overall camera 500 is not within the imaging range of the device camera 214 provided in the display 200. In this example, there is a situation in which the common nearby persons 42 are located both within the imaging range of the overall camera 500 and within the imaging range of the device camera 214.

In this example, the CPU 11a of the management server 300 acquires a video acquired by the overall camera 500 and showing the display 200 and the common nearby persons 42 (step S301). This video will be referred to as an “overall video” hereinafter.

Furthermore, in this example, the CPU 11a of the management server 300 acquires a video acquired by the device camera 214 and showing the common nearby persons 42 (step S302). This video will be referred to as an “individual/nearby-person video”.

Thereafter, the CPU 11a of the management server 300 generates parameters on the basis of the overall video and the individual/nearby person videos (step S303).

As with the above description, order of steps S301 to S302 is not limited. The processing in step S302 may be executed first, and the processing in step S301 may be executed later.

In this example, an individual/nearby person video as an example of the first video and an overall video as an example of the second video are acquired. The parameters are then generated on the basis of the two videos, namely the first image and the second image.

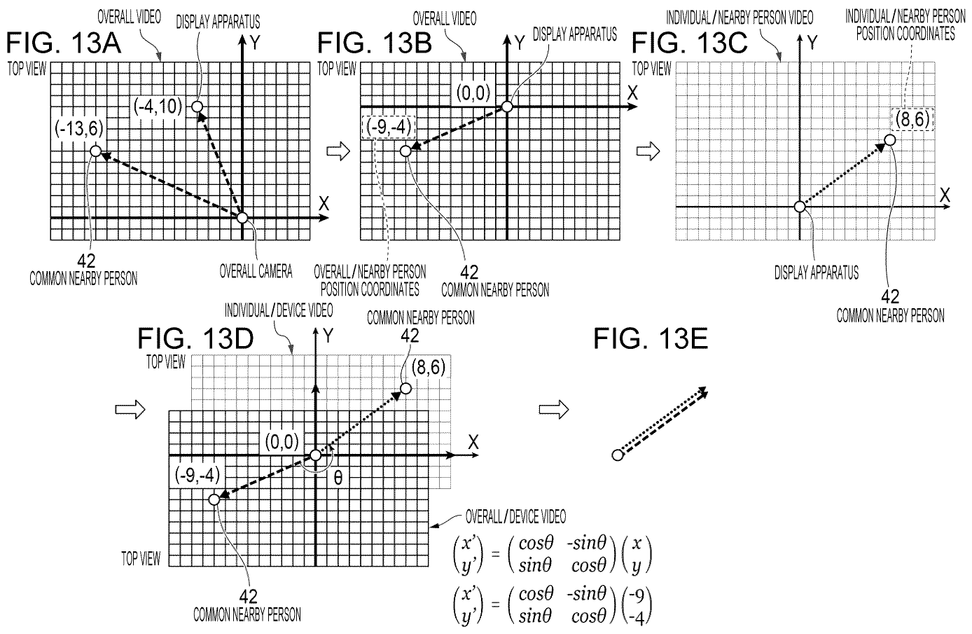

FIGS. 13A to 13E are diagrams illustrating details of the process for generating the parameters.

In this example, as illustrated in FIG. 13A, the CPU 11a of the management server 300 identifies position coordinates of the display 200 shown in the overall video on the basis of the overall video acquired by the overall camera 500.

Furthermore, as illustrated in FIG. 13A, the CPU 11a of the management server 300 identifies position coordinates of the common nearby persons 42 shown in the overall video.

As a result, the CPU 11a of the management server 300 identifies the two types of position coordinates.

Next, as illustrated in FIG. 13B, on the basis of the two identified types of position coordinates, the CPU 11a of the management server 300 acquires the position coordinates of the common nearby persons 42 in a case where the position of the display 200 is set as an origin.

The position coordinates will be referred to as “overall/nearby person position coordinates” hereinafter.

Next, as illustrated in FIG. 13C, the CPU 11a of the management server 300 analyzes the individual/nearby person video and identifies the position coordinates of the common nearby persons 42 with the location of the display 200 as the origin. The position coordinates will be referred to as “individual/nearby person position coordinates” hereinafter.

Thereafter, as illustrated in FIGS. 13D and 13E, the CPU 11a of the management server 300 generates parameters including projective transformation values and scaling correction values on the basis of the “overall/nearby person position coordinates” and the “individual/nearby person position coordinates”.

A method for generating the parameters based on the “overall/nearby position coordinates” and the “individual/nearby position coordinates” is the same as the method described above.

When the parameters are generated by performing the process illustrated in FIG. 13, the user needs to set the display 200 in an upright position and set the overall camera 500 in an upright position.

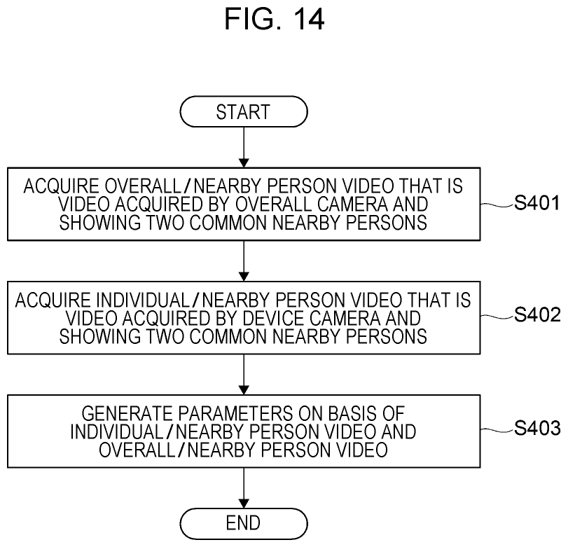

FIG. 14 is a diagram illustrating another example of the process for generating the parameters.

In this example, the parameters are generated on the basis only the common nearby persons 42. In this example, two common nearby persons 42 are present in each of the imaging range of the overall camera 500 and the imaging range of the device camera 214.

In this example, these two common nearby persons 42 are used to generate the parameters.

In this example, the CPU 11a of the management server 300 acquires an overall/nearby person video that is a video acquired by the overall camera 500 and showing the two common nearby persons 42 (step S401).

Furthermore, in this example, the CPU 11a of the management server 300 acquires an individual/nearby person video that is a video acquired by the device camera 214 and showing two common nearby persons 42 (step S402).

Also in this case, the overall/nearby person video and the individual/nearby person video are acquired such that a timing at which the overall/nearby person video is acquired and a timing at which the individual/nearby person video is acquired coincide with each other.

Thereafter, the CPU 11a of the management server 300 generates the parameters on the basis of the individual/nearby person video and the overall/nearby person video (step S403).

As with the above description, order of steps S401 and S402 is not limited. Step S402 may be executed first, and then the processing in step S401 may be executed.

In this example, an individual/nearby person video as an example of the first video and an overall/nearby person video as an example of the second video are acquired. The parameters are then generated on the basis of the two videos, namely the first image and the second image.

There may be a case where three or more common nearby persons 42 are shown in each of the overall/nearby person video and the individual/nearby person video. In this case, the CPU 11a of the management server 300 selects two common nearby persons 42 from among the three or more common nearby persons 42.

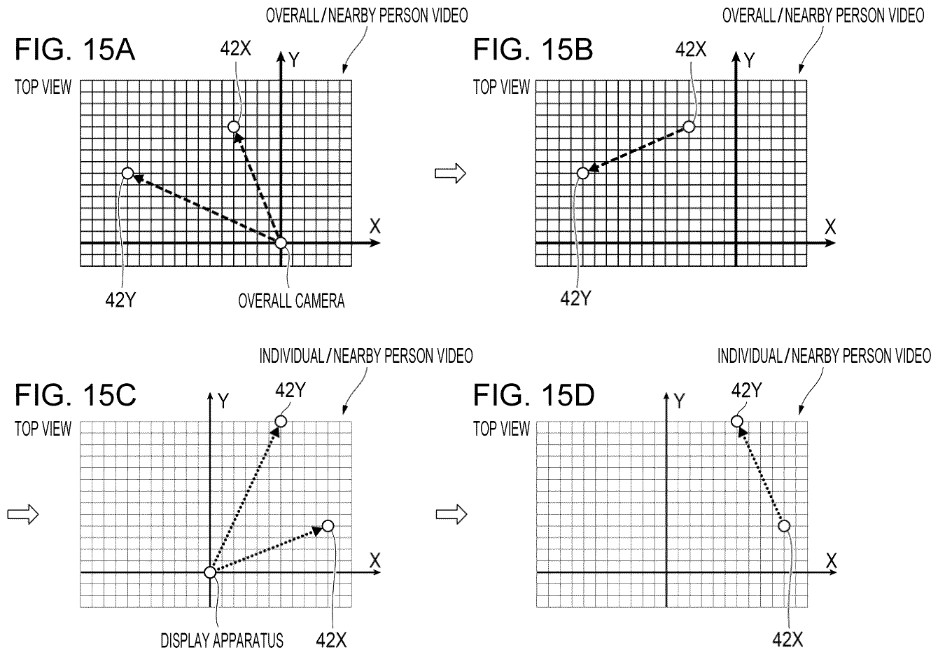

FIGS. 15A to 15D are diagrams illustrating details of the process.

In this example, first, as illustrated in FIG. 15A, the CPU 11a of the management server 300 acquires position coordinates of one 42X of the common nearby persons and position coordinates of another common nearby person 42Y on the basis of the overall/nearby person video acquired by the overall camera 500.

In this case, the CPU 11a of the management server 300 acquires two sets of position coordinates.

As illustrated in FIG. 15B, on the basis of the two sets of position coordinates, the CPU 11a of the management server 300 acquires the position coordinates of the other common nearby person 42Y in a case where the position of the common nearby person 42X is set as an origin. The position coordinates will be referred to as “overall/relative position coordinates” hereinafter.

As illustrated in FIG. 15C, the CPU 11a of the management server 300 acquires the position coordinates of the common nearby person 42X and the position coordinates of the other common nearby person 42Y on the basis of the individual/nearby person video acquired by the device camera 214.

Also in this case, the CPU 11a of the management server 300 acquires two sets of position coordinates.

Also in this case, as illustrated in FIG. 15D, on the basis of the two sets of position coordinates, the CPU 11a of the management server 300 acquires the position coordinates of the other common nearby person 42Y in a case where the position of the common nearby person 42X is set as an origin. The position coordinates will be referred to as “individual/relative position coordinates” hereinafter.

Thereafter, in the same manner as described above, the CPU 11a of the management server 300 generates parameters including projective transformation values and scaling correction values on the basis of the “overall/relative position coordinates” and the “individual/relative position coordinates”.

A method for generating the parameters based on the “overall/relative position coordinates” and the “individual/relative position coordinates” is the same as the generation method described above.

When the parameters are generated by performing the process illustrated in FIG. 15, the user needs to set the display 200 in an upright position and set the overall camera 500 in an upright position.

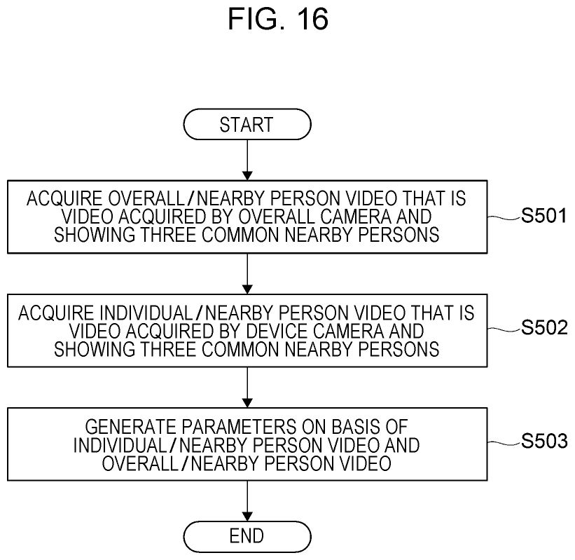

FIG. 16 is a diagram illustrating another example of the process for generating the parameters.

Also in this example, the parameters are generated on the basis of only the common nearby persons 42.

In this example, three common nearby persons 42 are present in each of the imaging range of the overall camera 500 and the imaging range of the device camera 214. In this example, these three common nearby persons 42 are used to generate the parameters.

In this example, the CPU 11a of the management server 300 acquires an overall/nearby person video that is a video acquired by the overall camera 500 and showing three common nearby persons 42 appear (step S501).

Furthermore, in this example, the CPU 11a of the management server 300 acquires an individual/nearby person video that is a video acquired by the device camera 214 and showing the three common nearby persons 42 (step S502).

There may be a case where four or more common nearby persons 42 are shown in each of the overall/common nearby person video and the individual/common nearby person video. In this case, the CPU 11a of the management server 300 selects three common nearby persons 42 from among the four or more common nearby persons 42.

Thereafter, the CPU 11a of the management server 300 generates the parameters on the basis of the individual/nearby person video and the overall/nearby-person videos (step S503).

As with the above description, order of steps S501 and S502 is not limited. Step S502 may be executed first, and then the processing in step S501 may be executed.

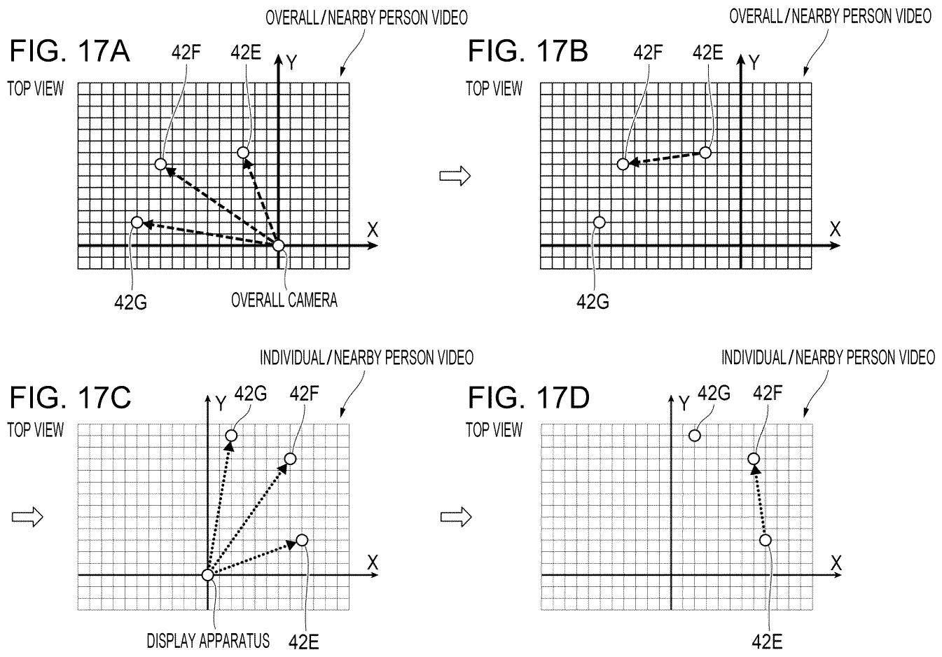

FIGS. 17A to 17D are diagrams illustrating details of the process.

In this example, first, as illustrated in FIG. 17A, the CPU 11a of the management server 300 acquires position coordinates of each of a first common nearby person 42E, a second common nearby person 42F, and a third common nearby person 42G on the basis of the overall/nearby person video acquired by the overall camera 500.

The first common nearby person 42E, the second common nearby person 42F, and the third common nearby person 42G are common nearby persons 42 included in the three common nearby persons 42 described above.

Next, as illustrated in FIG. 17B, for example, the CPU 11a of the management server 300 acquires the position coordinates of the second common nearby person 42F in a case where a position of the first common nearby person 42E is set as an origin.

The position coordinates of the second common nearby person 42F will be referred to as “overall/second nearby person position coordinates”.

As illustrated in FIG. 17C, the CPU 11a of the management server 300 acquires the position coordinates of each of the first common nearby person 42E, the second common nearby person 42F, and the third common nearby person 42G on the basis of the individual/nearby person video acquired by the device camera 214.

As illustrated in FIG. 17D, the CPU 11a of the management server 300 acquires the position coordinates of the second common nearby person 42F in a case where the position of the first common nearby person 42E is set as the origin.

The position coordinates of the second common nearby person 42F will be referred to as “individual/second nearby person position coordinates” hereinafter.

Thereafter, the CPU 11a of the management server 300 generates temporary parameters including projective transformation values and scaling correction values on the basis of the overall/second nearby person position coordinates and the individual/second nearby person position coordinates.

A method for generating the temporary parameters is the same as described above.

Thereafter, using the generated temporary parameters, the CPU 11a of the management server 300 transforms the position coordinates of the third common nearby person 42G in the imaging coordinate system into position coordinates in the display coordinate system.

Using the generated temporary parameters, the CPU 11a of the management server 300 transforms the position coordinates of the third common nearby person 42G shown in the overall/nearby person video illustrated in FIG. 17A into position coordinates in the display coordinate system.

The position coordinates acquired by the transformation correspond to the parameter-using position coordinates.

Next, the CPU 11a of the management server 300 compares the parameter-using position coordinates with the parameter-non-using position coordinates, which are the position coordinates of the third common nearby person 42G shown in the individual/nearby person video illustrated in FIG. 17D.

When the parameter-using position coordinates match the parameter-non-using position coordinates, the CPU 11a of the management server 300 sets the temporary parameters as final parameters.

On the other hand, when the parameter-using position coordinates do not match the parameter-non-using position coordinates, the CPU 11a of the management server 300 acquires correction projective transformation values as described above.

As described above, the CPU 11a of the management server 300 acquires correction projective transformation values on the basis of the parameter-using position coordinates and the parameter-non-using position coordinates.

The CPU 11a of the management server 300 then sets, as the final parameters, parameters including initial projective transformation values, which are projective transformation values acquired when the temporary parameters are generated, and the correction projective transformation values.

A case where the position coordinates of the out-of-sight nearby person 42B are transformed using the parameters including the initial projective transformation values and the correction projective transformation values.

In this case, first, the initial projective transformation values are used to transform the position coordinates of the out-of-sight nearby person 42B in the imaging coordinate system into the first position coordinates in the display coordinate system.

Next, using the correction projective transformation values, the first position coordinates are transformed into other position coordinates in the display coordinate system. The other position coordinates are set as final position coordinates of the out-of-sight nearby person 42B.

Process for Acquiring Position Coordinates

In the present exemplary embodiment, as described above, the position coordinates of a target object, such as a nearby person 42 or the display 200, are acquired on the basis of a distance between an origin and the target object and a direction from the origin toward the target object. In other words, the position coordinates of the target object are acquired on the basis of the vector from the origin toward the target object.

In this case, as described above, magnitude of the vector in an X direction is set as a position coordinate in the X direction, and magnitude of the vector in a Y direction is set as a position coordinate in the Y direction. Magnitude of the vector in a Z direction is set as position coordinates in the Z direction.

When identifying the position coordinates, it is necessary to identify the distance between the origin and the target object.

In the present exemplary embodiment, a distance between the overall camera 500 and a target object is identified on the basis of a size, in an apparatus video, of the target object shown in the apparatus video, which is a video acquired by the overall camera 500.

In the present exemplary embodiment, individual dimension information, which is information representing dimensions of each target object, is stored in advance in the information storage 19 illustrated in FIG. 2.

In the present exemplary embodiment, a relationship table that defines a relationship between the size of a target object in the apparatus video and the distance between the overall camera 500 and the target object is stored in advance in the information storage 19.

In the relationship table, a relationship between a distance between a target object having a reference length, such as 1 m, and the overall camera 500 and the size of the target object in the apparatus video is registered.

In other words, a relationship between the size of a captured object shown in the apparatus video and a distance between the captured object and the overall camera 500 is registered in the relationship table.

When identifying the distance between the origin and the target object, the CPU 11a of the management server 300 first identifies the target object shown in the apparatus video acquired by the overall camera 500.

When the target object is, for example, a nearby person 42, the CPU 11a of the management server 300 identifies the nearby person 42 by using face information.

When the target object is the display 200 or the like, the CPU 11a of the management server 300 performs image matching processing to identify the target object.

The CPU 11a of the management server 300 then reads and acquires individual dimension information about the identified target object from the information storage 19.

On the basis of the size of the target object in the apparatus video, the relationship table, and the acquired individual dimension information, the CPU 11a of the management server 300 identifies the distance between the overall camera 500 and the target object.

Thereafter, the CPU 11a of the management server 300 acquires position coordinates of the target object in the imaging coordinate system on the basis of the identified distance and the direction of the target object as viewed from the overall camera 500.

In this case, the CPU 11a of the management server 300 acquires the position coordinates of the target object in the imaging coordinate system on the basis of a vector from the overall camera 500 toward the target object.

The direction mentioned above corresponds to an angle between a reference direction of the overall camera 500 and the direction from the overall camera 500 toward the target object.

A method for identifying a distance when the overall camera 500 is used has been described above. With regard to a target object shown in a video acquired by the device camera 214 provided for the display 200, a distance between the display 200 and the target object is also identified by the same identification method.

The CPU 11a of the management server 300 then determines position coordinates corresponding to the parameter-non-using position coordinates on the basis of the distance and the direction of the target object shown in the video acquired by the device camera 214.

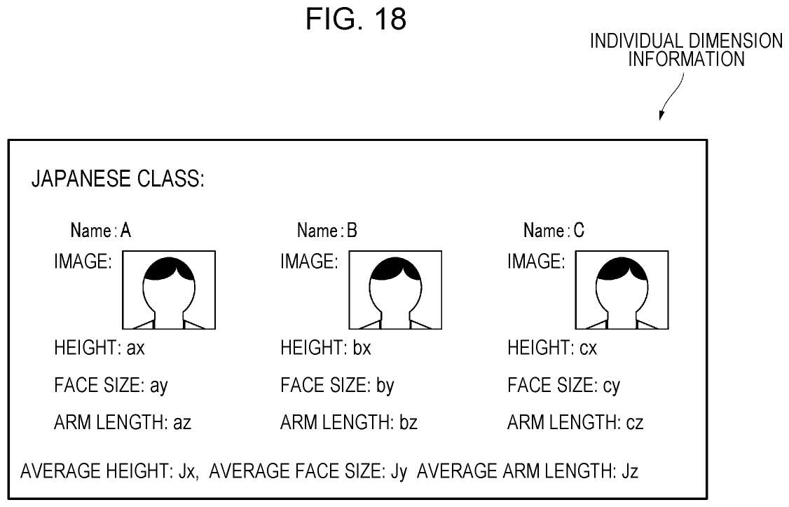

FIG. 18 is a table illustrating the individual dimension information stored in the information storage 19.

In the example illustrated in FIG. 18, dimension information about persons is registered as the individual dimension information. In the present exemplary embodiment, dimension information is individually registered for each person. In the present exemplary embodiment, dimension information about a person is stored for each person in the information storage 19 as an example of an information storage.

In the present exemplary embodiment, dimension information about each of body parts of a person is registered in advance for each person who can be a nearby person 42.

The CPU 11a of the management server 300 identifies each of nearby persons 42 on the basis of a video acquired by the overall camera 500 and a video acquired by the device camera 214.

The CPU 11a then reads and acquires individual dimension information corresponding to the identified nearby person 42 from the information storage 19. The CPU 11a reads and acquires the individual dimension information stored in the information storage 19 in association with the nearby person 42 shown in the video.

The CPU 11a then identifies a distance between the overall camera 500 and the nearby person 42 and a distance between the display 200 and the nearby person 42 on the basis of the size of the nearby person 42 in the video, the information registered in the relationship table, and the individual dimension information.

In other words, the CPU 11a identifies the distance between the overall camera 500 and the nearby person 42 and the distance between the display 200 and the nearby person 42 on the basis of dimensions of the nearby person 42 in the video, the information registered in the relationship table, and the individual dimension information.

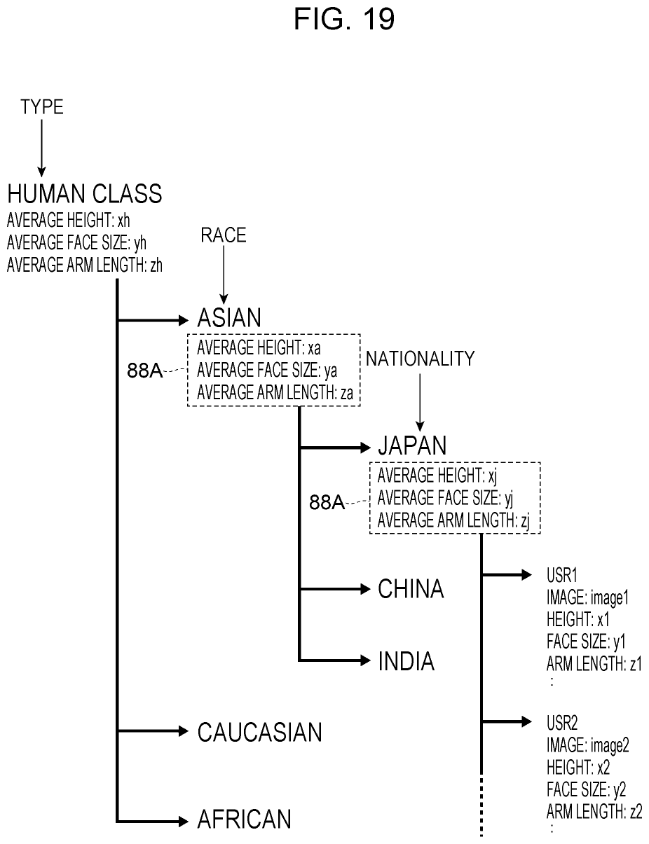

FIG. 19 is a diagram illustrating attributes of nearby persons 42.

Alternatively, an attribute of a nearby person 42 may be identified on the basis of a video acquired by the overall camera 500 or the device camera 214. A distance between the nearby person 42 and the overall camera 500 or the display 200 may then be identified on the basis of the identified attribute.

As illustrated in FIG. 19, for example, the attribute may be race and nationality.

When the distance is to be identified on the basis of the attribute of the nearby person 42, dimensional information 88A about each of body parts for each attribute is stored in advance in the information storage 19 as the individual dimensional information as illustrated in FIG. 19.

In this case, the dimension information 88A about each of body parts for each attribute is stored in the information storage 19 in association with the attribute.

When identifying the distance, first, the attribute of the nearby person 42 shown in the video is identified on the basis of a video acquired by the overall camera 500 or the device camera 214. Specifically, as described above, for example, the race of the nearby person 42 and the nationality of the nearby person 42 are identified.

The attribute of the nearby person 42 is identified using, for example, AI.

Specifically, in this case, a trained model acquired by machine learning using teacher data including videos of persons and information about attributes of the persons is prepared in advance. With use of the trained model, the attribute of the nearby person 42 shown in the video is identified.

After identifying the attribute, the CPU 11a of the management server 300 reads and acquires individual dimension information associated with the attribute.

On the basis of the size of the nearby person 42 in the video, the information registered in the relationship table, and the acquired individual dimension information, the CPU 11a identifies the distance between the overall camera 500 or the display 200 and the nearby person 42.

When the attribute of the nearby person 42 is identified, a plurality of attributes might be identified. In this case, the distance is preferably identified using individual dimension information associated with a lower-level attribute.

For example, in FIG. 19, the highest attribute is “type”, the second highest attribute is “race”, and the third highest attribute is “nationality”.

In this case, the nearby person 42 belongs to all of these attributes. In other words, in this case, the nearby person 42 belongs to a plurality of attributes.

In this case, it is preferable to identify the distance using individual dimension information corresponding to the lowest attribute among the plurality of attributes, such as nationality.

### Identification of Distance with Omnidirectional Camera

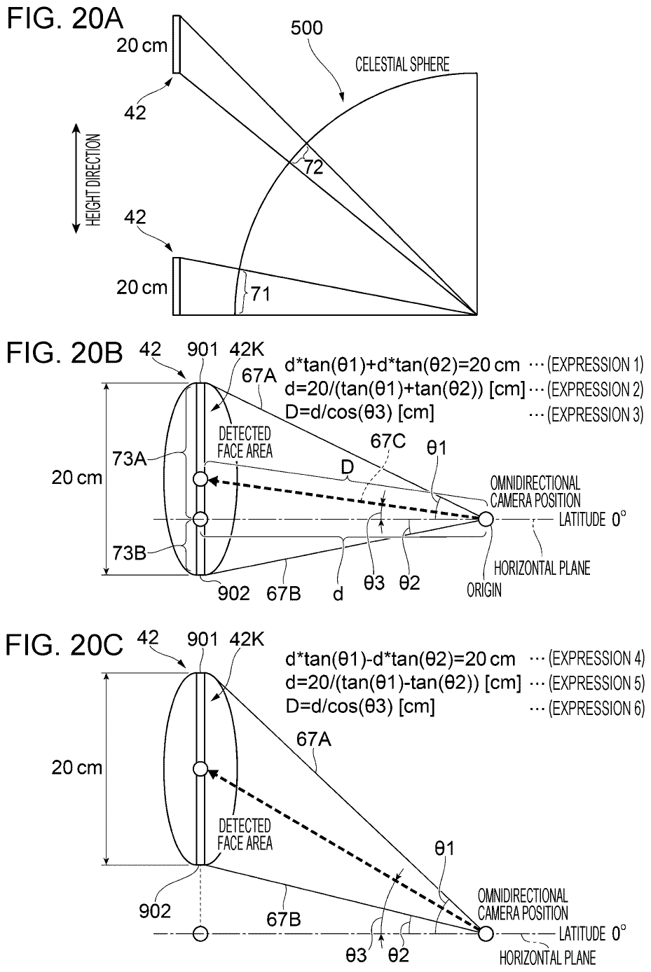

FIGS. 20A to 20C are diagrams illustrating a method for identifying a distance when the overall camera 500 is an omnidirectional camera.

When an omnidirectional camera is used, the size of the nearby person 42 in a video image acquired by the omnidirectional camera 500 varies (71 and 72) depending on a position of the nearby person 42 in the height direction as illustrated in FIG. 20A. Specifically, the size in a height direction varies.

In this case, accuracy of distance identification is likely to decrease.

Therefore, in the present exemplary embodiment, when an omnidirectional camera is used, the CPU 11a of the management server 300 performs the process illustrated in FIG. 20B to identify the distance.

When the process illustrated in FIG. 20B is performed, as described above, the individual dimension information is stored in advance in the information storage 19. In this example, information indicating that a face size is 20 cm is stored as the individual dimension information. The information indicating that the face size is 20 cm corresponds to registered information, which is information registered in advance about the size of the face of the nearby person 42 in a vertical direction.

With this process, first, a distance d between a position of a face 42K of the nearby person 42 on a horizontal plane and an origin in a case where the face 42K is projected onto the horizontal plane is identified using Expressions 1 and 2.

In the present exemplary embodiment, in FIG. 20B, the sum of a length of a portion 73A and a length of a portion 73B is 20 cm.

In this case, Expression 1 is satisfied. By transforming Expression 1 into Expression 2, the distance d can be acquired.

θ1 in Expression 1 represents an angle between an upper end 901 of the face 42K and the horizontal plane in a case where the upper end 901 is viewed from the origin of the omnidirectional camera. More specifically, θ1 denotes an angle between a straight line 67A connecting the origin of the omnidirectional camera and the upper end 901 of the face 42K and the horizontal plane.

θ2 in Expression 1 denotes an angle between a lower end 902 of the face 42K and the horizontal plane in a case where the lower end 902 is viewed from the origin of the omnidirectional camera. More specifically, θ2 indicates an angle between a straight line 67B connecting the origin of the omnidirectional camera and the lower end 902 of the face 42K and the horizontal plane.

The distance d is the distance between the face 42K and the omnidirectional camera on the horizontal plane. In other words, the distance d refers to a length of a straight line connecting the face 42K on the horizontal plane and the origin of the omnidirectional camera in a case where the face 42K is projected onto the horizontal plane.

The distance d corresponds to a horizontal plane linear distance, which is a linear distance on the horizontal plane between the face 42K and the omnidirectional camera.

Thereafter, in this example, the distance D is acquired using Expression 3. As a result, the distance between the face 42K and the omnidirectional camera is acquired. In other words, the distance between the nearby person 42 and the omnidirectional camera is acquired. As a result, it is also possible to acquire the position information about the nearby person 42 using this distance. This position information is position information in the imaging coordinate system.

Here, θ3 in Expression 3 denotes an angle between a straight line 67C from the omnidirectional camera toward the center of the face 42K and the horizontal plane. In other words, θ3 in Expression 3 denotes an angle between a straight line connecting a middle portion, which is a portion located between the upper end 901 and the lower end 902 of the face 42K, and the center of the omnidirectional camera and the horizontal plane.

Alternatively, as illustrated in FIG. 20C, the lower end 902 of the face 42K might be located above the horizontal plane.

In this case, the CPU 11a of the management server 300 calculates the distance D between the nearby person 42 and the omnidirectional camera using Expressions 4 to 6.

The present invention has been described above. The present invention is also applicable to a program and a program product.

### Appendix

(((1)))

An information processing system that generates a video to be displayed by a display which displays a video within a field of view of a user who views a real space and which includes an imager facing a direction of the user's gaze comprising a processor configured to acquire out-of-range information, which is information about an out-of-range space, which is a space located near the display and located outside an imaging range of the imager, and generate, as a display video, which is the video to be displayed by the display, a display video that reflects the acquired out-of-range information.

(((2)))

The information processing system according to (((1))), wherein the processor is configured to acquire, as the out-of-range information, target object information that is information about a specific target object located in the out-of-range space, and generate, as the display video, a display video that reflects the target object information.

(((3)))

The information processing system according to (((2))), wherein the processor is configured to: acquire, as the target object information, position information about the specific target object located in the out-of-range space, and generate, as the display video, a display video that reflects the position information about the specific target object.

(((4)))

The information processing system according to (((3))), wherein the processor is configured to generate a display video showing the image corresponding to the specific target object in the generated display video at a position identified from the position information.

(((5)))

The information processing system according to (((4))), wherein the specific target object is a person, and wherein the processor is configured to generate a display video showing an image representing content of an utterance of a person in the generated display video at the position identified from the position information.

(((6)))

The information processing system according to (((4))), wherein the specific target object is a person, and wherein the processor is configured to generate a display video showing an image representing a name of the person in the generated display video at the position identified from the position information.

(((7)))

The information processing system according to any of (((1))) to (((6))), wherein the processor is configured to generate the display video on a basis of an imager video, which is a video acquired by the imager provided for the display, and the acquired out-of-range information.

(((8)))

The information processing system according to (((7))), wherein the processor is configured to acquire, as the out-of-range information, information about a specific target object located in the out-of-range space, and generate, as the display video, a video acquired by adding the information about the specific target object to the imager video.

(((9)))

The information processing system according to (((8))), wherein the processor is configured to acquire, as the out-of-range information, position information about the specific target object located in the out-of-range space, and generate, as the display video, a video acquired by adding the information about the specific target object in the imager video at a position identified from the position information.

(((10)))

The information processing system according to any of (((1))) to (((9))), wherein the processor is configured to acquire, as the out-of-range information, information acquired on a basis of an apparatus video, which is a video acquired by an imaging apparatus that is provided separately from the display and that captures an image of the out-of-range space.

(((11)))

The information processing system according to (((10))), wherein the processor is configured to generate the display video on a basis of an imager video, which is a video acquired from the imager provided for the display, and information acquired on a basis of the apparatus video.

(((12)))

The information processing system according to (((10))), wherein the information acquired on the basis of the apparatus video is position information about a specific target object present in the out-of-range space, and wherein the processor is configured to generate a display video showing an image corresponding to the specific target object in the generated display video at an image corresponding to the specific target object.

(((13)))

The information processing system according to any of (((1))) to (((12))), wherein the processor is configured to generate, as the display video to be displayed by the display, a video that reflects the out-of-range information and in-range information, which is information about an in-range space, which is a space located within the imaging range of the imager.

(((14)))

The information processing system according to (((13))), wherein the processor is configured to cause the generated display video to reflect, as the in-range information, information acquired on a basis of a video acquired by imaging the in-range space using the imager of the display.

(((15)))

The information processing system according to any of (((1))) to (((14))), wherein the out-of-range information is position information about a specific target object located in the out-of-range space, wherein position information about the specific target object in an imaging coordinate system, which is a coordinate system of an imaging apparatus that is provided separately from the display and that images the out-of-range space, on a basis of an apparatus video, which is a video acquired by the imaging apparatus, is acquired, and wherein the processor is configured to transform the position information about the specific target object in the imaging coordinate system into position information in a display coordinate system, which is a coordinate system of the display, and generate, as the generated display video, a display video that reflects the position information about the specific target object in the display coordinate system.

(((16)))

The information processing system according to (((15))), wherein the processor is configured to transform, using a parameter for transformation of position information, the position information about the specific target object in the imaging coordinate system into the position information in the display coordinate system, acquire a first video, which is a video acquired by the imager of the display and showing the imaging apparatus, and acquire a second video, which is a video acquired by the imaging apparatus and showing the display, and wherein the parameter is generated on a basis of the first video showing the imaging apparatus and the second video showing the display.

(((17)))

The information processing system according to (((16))), wherein the processor is configured to further acquire a third video, which is a video acquired by the imager of the display and showing a specific target object; and further acquire a fourth video, which is a video acquired by the imaging apparatus and showing the specific target object shown in the third video, and wherein the parameter is generated on a basis of the first video, the second video, the third video, and the fourth video.

(((18)))

The information processing system according to (((15))), wherein the processor is configured to acquire a first video, which is a video acquired by the imager of the display and showing a specific target object, acquire a second video, which is a video acquired by the imaging apparatus and showing the display and the specific target object shown in the first video, generate a parameter for transformation of position information on a basis of the first video and the second video, and transform, using the parameter, position information about the specific target object in the imaging coordinate system into position information in the display coordinate system.

(((19)))

The information processing system according to (((15))), wherein the processor is configured to acquire a first video, which is a video acquired by the imager of the display and showing a first specific target object and a second specific target object, acquire a second video, which is a video acquired by the imaging apparatus and showing the first specific target object and the second specific target object shown in the first video, generate a parameter for transformation of position information on a basis of the first video and the second video, and transform, using the parameter, position information about the specific target objects in the imaging coordinate system into position information in the display coordinate system.

(((20)))

The information processing system according to (((15))), wherein the imaging apparatus is an omnidirectional camera, and wherein the processor is configured to acquire the position information about the specific target object in the imaging coordinate system on a basis of the apparatus video acquired by the omnidirectional camera; identify, on a basis of registration information about a size of the specific target object in a vertical direction registered in advance, an angle between a straight line connecting an upper end of the specific target object shown in the video acquired by the omnidirectional camera and a center of the omnidirectional camera and a horizontal plane, and an angle between a straight line connecting a lower end of the specific target object shown in the video acquired by the omnidirectional camera and the center of the omnidirectional camera and the horizontal plane, a horizontal plane linear distance, which is a linear distance on the horizontal plane from the specific target object to the omnidirectional camera, and acquire, on a basis of an angle between a straight line connecting a middle portion, which is a portion of the specific target object shown in the video acquired by the omnidirectional camera located between the upper end and the lower end and the center of the omnidirectional camera and the horizontal plane and the identified horizontal plane linear distance, position information about the specific target object in the imaging coordinate system.

(((21)))

The information processing system according to (((15))), wherein the processor is configured to acquire the position information about the specific target object in the imaging coordinate system, which is the coordinate system of the imaging apparatus, on a basis of the apparatus video, wherein dimension information about a specific target object is stored in an information storage for each specific target object, and wherein the processor is configured to identify, on a basis of dimensions identified from dimension information stored in the information storage in association with the specific target object shown in the apparatus video, dimensions, in the apparatus video, of the specific target object shown in the apparatus video, and information registered in a relationship table, in which a relationship between a size, in the apparatus video, of a captured object shown in the apparatus video and a distance between the captured object and the imaging apparatus, the distance between the specific target object and the imaging apparatus, and acquire the position information about the specific target object in the imaging coordinate system on a basis of the identified distance.

(((22)))

The information processing system according to (((3))), wherein the processor is configured to further generate, on a basis of the position information about the specific target object, control information for control of the display and for control other than the display control.

(((23)))

A program executed by a computer that generates a video to be displayed by a display which displays a video within a field of view of a user who views a real space and which includes an imager facing a direction of a gaze of the user, the program causing the computer to execute a program comprising: acquiring out-of-range information, which is information about an out-of-range space, which is a space located near the display and outside an imaging range of the imager; and generating, as a display video, which is the video to be displayed by the display, a display video that reflects the acquired out-of-range information.

What is claimed is:

1. An information processing system that generates a video to be displayed by a display which displays a video within a field of view of a user who views a real space and which includes an imager facing a direction of the user's gaze, the information processing system comprising:
a processor configured to:
acquire out-of-range information, which is information about an out-of-range space, which is a space located near the display and located outside an imaging range of the imager; and
generate, as a display video, which is the video to be displayed by the display, a display video that reflects the acquired out-of-range information.

2. The information processing system according to claim 1,
wherein the processor is configured to:
acquire, as the out-of-range information, target object information that is information about a specific target object located in the out-of-range space; and
generate, as the display video, a display video that reflects the target object information.

3. The information processing system according to claim 2,
wherein the processor is configured to:
acquire, as the target object information, position information about the specific target object located in the out-of-range space; and
generate, as the display video, a display video that reflects the position information about the specific target object.

4. The information processing system according to claim 3,
wherein the processor is configured to:
generate a display video showing the image corresponding to the specific target object in the generated display video at a position identified from the position information.

5. The information processing system according to claim 4,
wherein the specific target object is a person, and
wherein the processor is configured to:
generate a display video showing an image representing content of an utterance of a person in the generated display video at the position identified from the position information.

6. The information processing system according to claim 4,
wherein the specific target object is a person, and
wherein the processor is configured to:
generate a display video showing an image representing a name of the person in the generated display video at the position identified from the position information.

7. The information processing system according to claim 1,
wherein the processor is configured to:
generate the display video on a basis of an imager video, which is a video acquired by the imager provided for the display, and the acquired out-of-range information.

8. The information processing system according to claim 1,
wherein the processor is configured to:
acquire, as the out-of-range information, information acquired on a basis of an apparatus video, which is a video acquired by an imaging apparatus that is provided separately from the display and that captures an image of the out-of-range space.

9. The information processing system according to claim 8,
wherein the processor is configured to:
generate the display video on a basis of an imager video, which is a video acquired from the imager provided for the display, and information acquired on a basis of the apparatus video.

10. The information processing system according to claim 8,
wherein the information acquired on the basis of the apparatus video is position information about a specific target object present in the out-of-range space, and
wherein the processor is configured to:
generate a display video showing an image corresponding to the specific target object in the generated display video at an image corresponding to the specific target object.

11. The information processing system according to claim 1,
wherein the processor is configured to:
generate, as the display video to be displayed by the display, a video that reflects the out-of-range information and in-range information, which is information about an in-range space, which is a space located within the imaging range of the imager.

12. The information processing system according to claim 11,
wherein the processor is configured to:
cause the generated display video to reflect, as the in-range information, information acquired on a basis of a video acquired by imaging the in-range space using the imager of the display.

13. The information processing system according to claim 1,
wherein the out-of-range information is position information about a specific target object located in the out-of-range space,
wherein position information about the specific target object in an imaging coordinate system, which is a coordinate system of an imaging apparatus that is provided separately from the display and that images the out-of-range space, on a basis of an apparatus video, which is a video acquired by the imaging apparatus, is acquired, and
wherein the processor is configured to:
transform the position information about the specific target object in the imaging coordinate system into position information in a display coordinate system, which is a coordinate system of the display; and
generate, as the generated display video, a display video that reflects the position information about the specific target object in the display coordinate system.

14. The information processing system according to claim 13,
wherein the processor is configured to:
transform, using a parameter for transformation of position information, the position information about the specific target object in the imaging coordinate system into the position information in the display coordinate system;
acquire a first video, which is a video acquired by the imager of the display and showing the imaging apparatus; and
acquire a second video, which is a video acquired by the imaging apparatus and showing the display, and
wherein the parameter is
generated on a basis of the first video showing the imaging apparatus and the second video showing the display.

15. The information processing system according to claim 14,
wherein the processor is configured to:
further acquire a third video, which is a video acquired by the imager of the display and showing a specific target object; and
further acquire a fourth video, which is a video acquired by the imaging apparatus and showing the specific target object shown in the third video, and
wherein the parameter is generated on a basis of the first video, the second video, the third video, and the fourth video.

16. The information processing system according to claim 13,
wherein the processor is configured to:
acquire a first video, which is a video acquired by the imager of the display and showing a specific target object;
acquire a second video, which is a video acquired by the imaging apparatus and showing the display and the specific target object shown in the first video;
generate a parameter for transformation of position information on a basis of the first video and the second video; and
transform, using the parameter, position information about the specific target object in the imaging coordinate system into position information in the display coordinate system.

17. The information processing system according to claim 13,
wherein the processor is configured to:
acquire a first video, which is a video acquired by the imager of the display and showing a first specific target object and a second specific target object;
acquire a second video, which is a video acquired by the imaging apparatus and showing the first specific target object and the second specific target object shown in the first video;
generate a parameter for transformation of position information on a basis of the first video and the second video; and
transform, using the parameter, position information about the specific target objects in the imaging coordinate system into position information in the display coordinate system.

18. The information processing system according to claim 13,
wherein the imaging apparatus is an omnidirectional camera, and
wherein the processor is configured to:
acquire the position information about the specific target object in the imaging coordinate system on a basis of the apparatus video acquired by the omnidirectional camera;
identify, on a basis of registration information about a size of the specific target object in a vertical direction registered in advance, an angle between a straight line connecting an upper end of the specific target object shown in the video acquired by the omnidirectional camera and a center of the omnidirectional camera and a horizontal plane, and an angle between a straight line connecting a lower end of the specific target object shown in the video acquired by the omnidirectional camera and the center of the omnidirectional camera and the horizontal plane, a horizontal plane linear distance, which is a linear distance on the horizontal plane from the specific target object to the omnidirectional camera; and
acquire, on a basis of an angle between a straight line connecting a middle portion, which is a portion of the specific target object shown in the video acquired by the omnidirectional camera located between the upper end and the lower end and the center of the omnidirectional camera and the horizontal plane and the identified horizontal plane linear distance, position information about the specific target object in the imaging coordinate system.

19. The information processing system according to claim 13,
wherein the processor is configured to acquire the position information about the specific target object in the imaging coordinate system, which is the coordinate system of the imaging apparatus, on a basis of the apparatus video,
wherein dimension information about a specific target object is stored in an information storage for each specific target object, and
wherein the processor is configured to:
identify, on a basis of dimensions identified from dimension information stored in the information storage in association with the specific target object shown in the apparatus video, dimensions, in the apparatus video, of the specific target object shown in the apparatus video, and information registered in a relationship table, in which a relationship between a size, in the apparatus video, of a captured object shown in the apparatus video and a distance between the captured object and the imaging apparatus, the distance between the specific target object and the imaging apparatus, and acquire the position information about the specific target object in the imaging coordinate system on a basis of the identified distance.

20. A non-transitory computer readable medium storing a program executed by a computer that generates a video to be displayed by a display which displays a video within a field of view of a user who views a real space and which includes an imager facing a direction of a gaze of the user, the program causing the computer to execute a program comprising:
acquiring out-of-range information, which is information about an out-of-range space, which is a space located near the display and outside an imaging range of the imager; and
generating, as a display video, which is the video to be displayed by the display, a display video that reflects the acquired out-of-range information.
